(19) United States
(12) Patent Application Publication
(10) Pub. No.: US 2010/0253962 A1
(43) Pub. Date: Oct. 7, 2010

(54) SIGNAL CONVERSION APPARATUS

(75) Inventors: Takafumi Higuchi, Matsumoto-shi (JP); Kenji Sakuda, Suwa-shi (JP); Yasuhiro Oshima, Matsumoto-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/752,038

(22) Filed: Mar. 31, 2010

(30) Foreign Application Priority Data
Apr. 1, 2009 (JP) 2009-089239

(51) Int. Cl. G06F 3/12

(52) U.S. Cl. 358/1.13; 358/407

(57) ABSTRACT

Provided is a signal conversion apparatus which is connected between a transmitting terminal which transmits printable printing contents according to an analog FAX protocol and a home gateway.

### CROSS-REFERENCE TO RELATED APPLICATIONS

The entire disclosure of Japanese Patent Application No. 2009-089239, filed Apr. 1, 2009 is expressly incorporated by reference herein.

### BACKGROUND

1. Technical Field

The present invention relates to a signal conversion apparatus.

2. Related Art

In the related art, there is well known a personal computer connected with a facsimile (FAX) or a printer that receives printing data through a communication network such as a telephone line or the Internet and prints the printing data. In the FAX that receive the printing data through the telephone line, a FAX signal responds with a call, and every time when the printing data are received, the printing is performed, or after the printing data are stored in a memory, the printing is performed. In the personal computer that receives the printing data through the Internet, the printing data are stored in an external storage unit such as a hard disk, and after that, a printing application is driven to read and print the printing data stored in the external storage unit. Such a technology for transmitting information through the network is disclosed in JP-A-2005-109701, JP-A-2003-178028, JP-T-2005-516320, or the like.

There is expected a technology for performing printing data transmission/reception between printers, which are connected to an IP (Internet Protocol) network and allocated with individual IP addresses, without intervention of a personal computer, that is, directly through the IP network. As a protocol for performing the printing data transmission/reception, an HTTP (HyperText Transfer Protocol) is considered. On the other hand, with respect to the FAX, the printing data transmission/reception has been performed through the PSTN (Public Switched Telephone Network) according to an analog FAX protocol such as T.30 scheme. In the FAX, by connecting the FAX to the IP network through a gateway that converts the analog FAX protocol into the digital FAX protocol such as a VoIP (Voice over Internet Protocol) gateway that converts the T.30 scheme into the audio scheme considered to be one of digital FAX protocols, the printing data transmission/reception through the IP network has been available in the related art. However, with respect to the FAX using the intervention of the gateway, although the printing data can be transmitted to an apparatus that perform the printing data transmission/reception according to the digital FAX protocol, the printing data transmission/reception cannot be transmitted to a printer that performs the printing data transmission/reception according to the HTTP.

### SUMMARY

An advantage of some aspects of the invention is to transmit printing data transmission/reception from a transmitting terminal that transmits the printing contents according to an analog FAX protocol to a receiving terminal that receives and prints the printing contents according to any one of a digital FAX protocol and an HTTP.

In order to achieve the advantage, the invention is implemented by the following aspects.

According to a first aspect of the invention, there is provided a signal conversion apparatus which is connected between a transmitting terminal which transmits printable printing contents according to an analog FAX protocol and a home gateway, which is connected to an IP network, to which a FAX receiving terminal that receives and prints the printing contents according to a digital FAX protocol or an HTTP receiving terminal that receives and prints the printing contents according to HTTP as a receiving terminal that receives and prints the printing contents is connected, which, when the transmitting terminal receives a connection request signal output in a format used for the analog FAX protocol so as to transmit the printing contents, performs a FAX protocol connection establishment process of performing data transmission/reception in the format used for the transmitting terminal and the analog FAX protocol and performing data transmission/reception through the IP network in the format used for the FAX receiving terminal and the digital FAX protocol to obtain connection establishment between the transmitting terminal and the FAX receiving terminal and a FAX protocol conversion process of receiving the printing contents in the format used for the analog FAX protocol from the transmitting terminal after the connection establishment, converting the received printing contents into the format used for the digital FAX protocol, and transmitting the converted printing contents to the FAX receiving terminal through the IP network, and which, when data in the format used for the HTTP is received, performs an HTTP relaying process of relaying the data without change, the signal conversion apparatus including: a first input/output unit which can input and output data through the transmitting terminal and a telephone line; a second input/output unit which can input and output data through the home gateway and a LAN cable; a third input/output unit which can input and output data through the home gateway and the telephone line; and a data transmission/reception unit which performs data transmission/reception with respect to the transmitting terminal by using the first input/output unit and data transmission/reception with respect to the home gateway by using the second input/output unit or the third input/output unit, wherein, when the connection request signal is received through the first input/output unit, the data transmission/reception unit performs an HTTP connection establishment process of trying to obtain the connection establishment between the transmitting terminal and the receiving terminal by performing the data transmission/reception in the format used for the transmitting terminal and the analog FAX protocol through the first input/output unit and performing the data transmission/reception in the format used for the receiving terminal and the HTTP through the second input/output unit, the home gateway, and the IP network, wherein, when the connection establishment can be obtained through the HTTP connection establishment process, the data transmission/reception unit performs an HTTP conversion process of transmitting the printing contents to the connected receiving terminal through the second input/output unit, the home gateway, and the IP network by considering the receiving terminal that tries to connect to be an HTTP receiving terminal, receiving the printing contents in the format used for the analog FAX protocol from the transmitting terminal through the first input/output unit, and converting the received printing contents into the format used for the HTTP, and wherein, when the connection establishment cannot be obtained through the HTTP connection establishment process, the data transmission/reception unit performs a FAX protocol relaying process of performing a process of considering the receiving terminal that tries to connect to be a FAX receiving terminal and transmitting the connection request signal, which is received through the first input/output unit, to the home gateway in the format used for the analog FAX protocol through the third input/output unit and a process of relaying the data, which are received and transmitted by the transmitting terminal and the home gateway, without change through the first input/output unit and the third input/output unit.

In the signal conversion apparatus according to the first aspect of the invention, if the connection request signal is received from the transmitting terminal, the HTTP connection establishment process is first performed, and the connection to the receiving terminal is tried. Next, when the connection establishment is obtained, the receiving terminal is considered to be the HTTP receiving terminal, and the printing contents is transmitted from the transmitting terminal to the receiving terminal through the HTTP conversion process. In addition, when the connection establishment is not obtained, the receiving terminal is considered to be the FAX receiving terminal, and the FAX protocol relaying process is performed. The home gateway that receives the connection request signal in the format used for the analog FAX protocol performs the FAX protocol connection establishment process and the FAX protocol conversion process, so that the printing contents can be transmitted from the transmitting terminal to the receiving terminal. In this manner, by connecting the first signal conversion apparatus according to the invention between the transmitting terminal that transmits the printing contents according to the analog FAX protocol and the home gateway that performs the protocol conversion between the analog FAX protocol and the digital FAX protocol, the printing contents can be transmitted from the transmitting terminal to the HTTP receiving terminal, and the printing contents transmission from the transmitting terminal to the FAX receiving terminal, which can be performed only by the transmitting terminal and the home gateway, is not disturbed. Accordingly, with respect to the receiving terminal that receives and prints the printing contents according to any one of the digital FAX protocol and the HTTP, the printing contents can be transmitted from the transmitting terminal that transmits the printing contents according to the analog FAX protocol. In addition, if the connection request signal is received, the HTTP connection establishment process is first performed, and according to whether or not the connection establishment is obtained, it is determined whether the receiving terminal is the HTTP receiving terminal or the FAX receiving terminal, and after that, the following processes are performed. Therefore, even in the case where it is unclear which one of the digital FAX protocol and the HTTP the receiving terminal receives and prints the printing contents according to, the printing contents can be transmitted to the receiving terminal.

The signal conversion apparatus according to the first aspect of the invention may further include a storage unit which can store identification information of the receiving terminal included in the connection request signal as identification information of the receiving terminal, of which the connection establishment cannot be obtained through the HTTP connection establishment process, wherein, when the connection request signal is received, before the HTTP connection establishment process is performed, the data transmission/reception unit determines whether or not the identification information of the receiving terminal included in the connection request signal is stored as the identification information of the receiving, of which the connection establishment cannot be obtained through the HTTP connection establishment process, in the storage unit, wherein, when an affirmative determination is made, the data transmission/reception unit considers the receiving terminal to be the FAX receiving terminal and performs the FAX protocol relaying process without performing of the HTTP connection establishment process, wherein, when a negative determination is made, the data transmission/reception unit performs the HTTP connection establishment process, wherein, when the connection establishment can be obtained through the HTTP connection establishment process, the data transmission/reception unit performs the HTTP conversion process, and wherein, when the connection establishment cannot be obtained through the HTTP connection establishment process, the data transmission/reception unit performs a process of storing the identification information of the receiving terminal that tries to connect as the identification information of the receiving terminal, of which the connection establishment cannot be obtained through the HTTP connection establishment process in the storage unit and performs the FAX protocol relaying process. Accordingly, with respect to the receiving terminal that is considered to be the FAX receiving terminal of which the connection establishment cannot be obtained through the one-time HTTP connection establishment process, in the case where the printing contents are transmitted later, the connection is initially established in the format used for a suitable protocol to the receiving terminal, so that the printing contents can be transmitted.

In the aspect, the storage unit may be a unit which stores time information indicating the storing time in correspondence with the identification information when the identification information is stored as the identification information of the receiving terminal, of which the connection establishment cannot be obtained through the HTTP connection establishment process, wherein, when the data transmission/reception unit receives the connection request signal and make an affirmative determination by performing the determination before the HTTP connection establishment process is performed, in the case where the identification information of the receiving terminal included in the received connection request signal and the time information indicating the time less than a predetermined time interval from the current time are stored in a correspondence manner, the data transmission/reception unit performs the FAX protocol relaying process without performing of the HTTP connection establishment process, wherein, in the case where the identification information of the receiving terminal included in the received connection request signal and the time information indicating the time more than a predetermined time interval before from the current time are stored in a correspondence manner, the data transmission/reception unit performs the HTTP connection establishment process, wherein, when the connection establishment can be obtained through the HTTP connection establishment process, the data transmission/reception unit performs the HTTP conversion process, and wherein, when the connection establishment cannot be obtained through the HTTP connection establishment process, the data transmission/reception unit performs the process of storing the identification information of the receiving terminal that tries to connect as the identification information of the receiving terminal in the storing unit, of which the connection establishment cannot be obtained through the HTTP connection establishment process and storing the time information indicating the storing time in correspondence with the identification information and the FAX protocol relaying process. Accordingly, even in the receiving terminal that is considered to be the FAX receiving terminal of which the connection establishment cannot be obtained through the one-time HTTP connection establishment process, if a predetermined time or more elapses, since the HTTP connection establishment process is tried, in the case where the receiving terminal has a function of receiving and printing the printing contents according to the HTTP, the printing contents can be detected, and after that, the printing contents can be transmitted according to the HTTP.

According to a second aspect of the invention, there is provided a signal conversion apparatus which is connected between a transmitting terminal which transmits printable printing contents according to an analog FAX protocol and an IP network to which an FAX receiving terminal that receives and prints the printing contents according to a digital FAX protocol or an HTTP receiving terminal that receives and prints the printing contents according to HTTP as a receiving terminal that receives and prints the printing contents is connected, the signal conversion apparatus including: a data transmission/reception unit which performs data transmission/reception with respect to the transmitting terminal and data transmission/reception with respect to the receiving terminal through the IP network, wherein, when a connection request signal that is transmitted by the transmitting terminal so as to transmit the printing contents is received, the data transmission/reception unit performs an HTTP connection establishment process of trying to obtain the connection between the transmitting terminal and the receiving terminal by performing the data transmission/reception in the format used for the transmitting terminal and the analog FAX protocol and performing the data transmission/reception in the format used for the receiving terminal and the HTTP through the IP network wherein, when the connection establishment can be obtained through the HTTP connection establishment process, the data transmission/reception unit performs an HTTP conversion process of transmitting the printing contents to the connected receiving terminal through the IP network by considering the receiving terminal that tries to connect to be an HTTP receiving terminal, receiving the printing contents in the format used for the analog FAX protocol from the transmitting terminal, and converting the received printing contents into the format used for the HTTP, wherein, when the connection establishment cannot be obtained through the HTTP connection establishment process, the data transmission/reception unit performs a FAX protocol connection establishment process of considering the receiving terminal that tries to connect as a FAX receiving terminal, performing data transmission/reception in the format used for the transmitting terminal and the analog FAX protocol, and performing data transmission/reception through the IP network in the format used for the receiving terminal and the digital FAX protocol to obtain connection establishment between the transmitting terminal and the receiving terminal and a FAX protocol conversion process of receiving the printing contents in the format used for the analog FAX protocol from the transmitting terminal after the connection establishment, converting the received printing contents into the format used for the digital FAX protocol, and transmitting the converted printing contents to the receiving terminal through the IP network.

In the signal conversion apparatus according to the second aspect of the invention, if the connection request signal is received from the transmitting terminal, the HTTP connection establishment process is first performed, and the connection is tried with the receiving terminal. Next, when the connection establishment is obtained, the receiving terminal is considered to be the HTTP receiving terminal, and the printing contents is transmitted from the transmitting terminal to the receiving terminal through the HTTP conversion process. In addition, when the connection establishment is not obtained, the receiving terminal is considered to be the FAX receiving terminal, and the FAX protocol connection establishment process is performed. After the connection establishment, the printing contents are transmitted from the transmitting terminal to the receiving terminal through the FAX protocol conversion process. Therefore, with respect to the receiving terminal that receives and prints the printing contents according to any one of the digital FAX protocol and the HTTP, the printing contents can be transmitted from the transmitting terminal that transmits the printing contents according to the analog FAX protocol. In addition, if the connection request signal is received, the HTTP connection establishment process is first performed, and according to whether or not the connection establishment is obtained, it is determined whether the receiving terminal is the HTTP receiving terminal or the FAX receiving terminal, and after that, the following processes are performed. Therefore, even in the case where it is unclear which one of the digital FAX protocol and the HTTP the receiving terminal receives and prints the printing contents according to, the printing contents can be transmitted to the receiving terminal.

The signal conversion apparatus according to the second aspect of the invention may further include a storage unit which can store identification information of the receiving terminal included in the connection request signal as identification information of the receiving terminal, of which the connection establishment cannot be obtained through the HTTP connection establishment process, wherein, when the connection request signal is received, before the HTTP connection establishment process is performed, the data transmission/reception unit determines whether or not the identification information of the receiving terminal included in the connection request signal is stored as the identification information of the receiving terminal, of which the connection establishment cannot be obtained through the HTTP connection establishment process, in the storage unit, wherein, when an affirmative determination is made, the data transmission/reception unit considers the receiving terminal to be the FAX receiving terminal and performs the FAX protocol connection establishment process without performing of the HTTP connection establishment process, and performs the FAX protocol conversion process after the connection establishment, wherein, when a negative determination is made, the data transmission/reception unit performs the HTTP connection establishment process, wherein, when the connection establishment can be obtained through the HTTP connection establishment process, the data transmission/reception unit performs the HTTP conversion process, wherein, when the connection establishment cannot be obtained through the HTTP connection establishment process, the data transmission/reception unit stores the identification information of the receiving terminal that tries to connect as the identification information of the receiving terminal, of which the connection establishment cannot be obtained through the HTTP connection establishment process in the storage unit and performs the FAX protocol connection establishment process, and performs the FAX protocol conversion process after the connection establishment. Accordingly, with respect to the receiving terminal that is considered to be the FAX receiving terminal of which the connection establishment cannot be obtained through the one-time HTTP connection establishment process, in the case where the printing contents are transmitted later, the connection is initially established in the format used for a suitable protocol, so that the printing contents can be transmitted.

In the aspect, the storage unit may be a unit which stores time information indicating the storing time in correspondence with the identification information when the identification information is stored as the identification information of the receiving terminal, of which the connection establishment cannot be obtained through the HTTP connection establishment process, wherein, when the data transmission/reception unit receives the connection request signal and make an affirmative determination by performing the determination before the HTTP connection establishment process is performed, in the case where the identification information of the receiving terminal included in the received connection request signal and the time information indicating the time less than a predetermined time interval from the current time are stored in a correspondence manner, the data transmission/reception unit performs the FAX protocol connection establishment process without performing of the HTTP connection establishment process, and performs the FAX protocol conversion process after the connection establishment, wherein, in the case where the identification information of the receiving terminal included in the received connection request signal and the time information indicating the time more than a predetermined time interval before from the current time are stored in a correspondence manner, the data transmission/reception unit performs the HTTP connection establishment process, wherein, when the connection establishment can be obtained through the HTTP connection establishment process, the data transmission/reception unit performs the HTTP conversion process, and wherein, when the connection establishment cannot be obtained through the HTTP connection establishment process, the data transmission/reception unit stores the identification information of the receiving terminal that tries to connect as the identification information of the receiving terminal in the storage unit, of which the connection establishment cannot be obtained through the HTTP connection establishment process and storing the time information indicating the storing time in correspondence with the identification information, performs the FAX protocol connection establishment process, and performs the FAX protocol conversion process after the connection establishment. Accordingly, even in the receiving terminal that is considered to be the FAX receiving terminal of which the connection establishment cannot be obtained through the one-time HTTP connection establishment process, if a predetermined time or more elapses, since the HTTP connection establishment process is tried, in the case where the receiving terminal has a function of receiving and printing the printing contents according to the HTTP, the printing contents can be detected, and after that, the printing contents can be transmitted according to the HTTP.

### BRIEF DESCRIPTION OF THE DRAWINGS

The invention will be described with reference to the accompanying drawings, wherein like numbers reference like elements.

FIG. 1 is a view illustrating a configuration of a printing system having a converter according to an embodiment of the invention.

FIG. 2 is a view illustrating sequences of a FAX apparatus and a multifunctional apparatus.

FIG. 3 is a view illustrating sequences of a printing contents transmission/reception process.

FIG. 4 is a flowchart illustrating an example of a protocol determination routine.

FIG. 5 is a view illustrating an example of contents of SDP in an INVITE message.

FIG. 6 is a view illustrating an example of contents of SDP of “200 OK”.

FIG. 7 is a view illustrating an example of contents of a transmission side capability request.

FIG. 8 is a view illustrating an example of contents of a transmission side capability response.

FIG. 9 is a view illustrating an example of contents of a page information request.

FIG. 10 is a view illustrating an example of contents of a page information response.

FIG. 11 is a view illustrating an example of contents of a data request.

FIG. 12 is a view illustrating an example of contents of a page information response in the case where there is no next page.

FIG. 13 is a view illustrating sequences of a FAX apparatus and another FAX apparatus.

FIG. 14 is a view illustrating sequences of a printing contents transmission/reception process.

FIG. 15 is a view illustrating identification information and time information stored in an identification information storage area.

### DESCRIPTION OF EXEMPLARY EMBODIMENTS

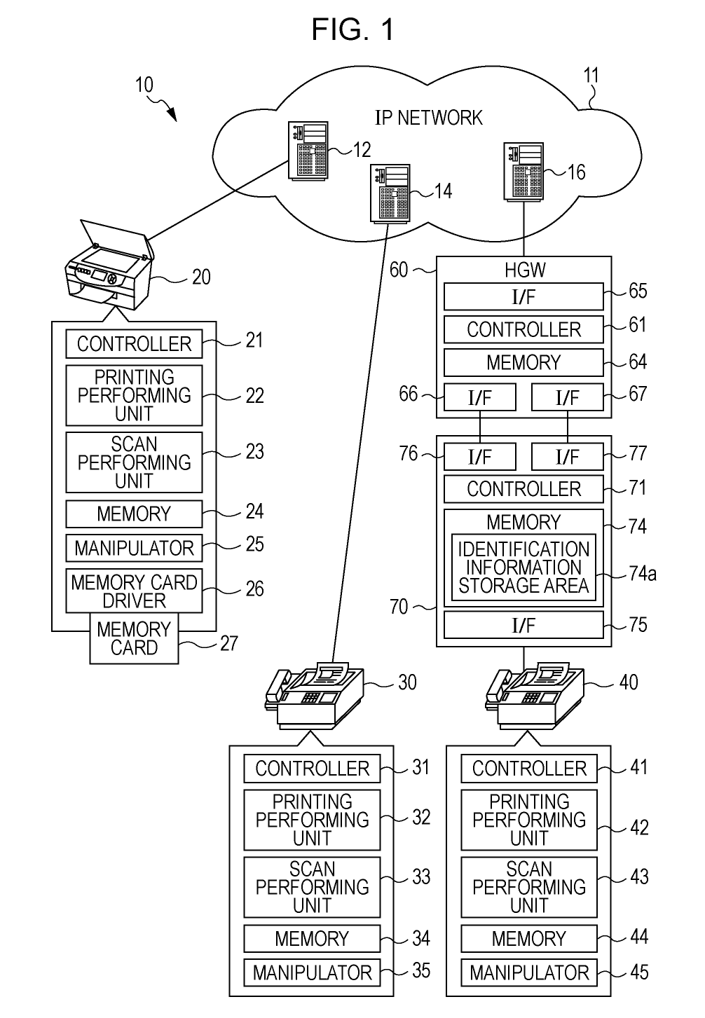

Hereinafter, embodiments of the invention are described with reference to the attached drawings. FIG. 1 is a schematic view illustrating an example of a configuration of a printing system 10 having a converter 70 according to an embodiment of the invention. As shown in the figure, the printing system 10 includes an IP network 11, a multifunctional apparatus 20 and a FAX apparatus 30 connected to the IP network 11, and a FAX apparatus 40 connected to the IP network 11 through a home gateway (HGW) 60 and the converter 70.

The IP network 11 is configured, for example, as an NGN (next generation network). The IP network 11 includes SIP (session initiation protocol) proxy servers 12, 14, and 16 that relay an IP message from a user agent such as the multifunctional apparatus 20 and the FAX apparatus 30 and 40 and a location server (not shown) that stores position information of the user agent (for example, URI (uniform resource identifier).

The multifunctional apparatus 20 is an apparatus that functions as a scanner as well as a printer. The multifunctional apparatus 20 is an apparatus that can receives and transmits printing contents including image data according to HTTP through the IP network 11. The multifunctional apparatus 20 is connected to the SIP proxy server 12 of the IP network 11 through an interface (I/F). The multifunctional apparatus 20 includes a controller 21 that controls the entire apparatus, a printing performing unit 22 that prints text or image data, a scan performing unit 23 that scans text or images on a medium such as paper to obtain image data, a memory 24 that stores various programs executed by the controller 21, temporarily stores to-be-printed data, or temporarily stores the image data obtained by the scanning, a manipulator 25 that displays various kinds of information to a user or receives various commands from the user as an input, and a memory card driver 26 that writes data to a memory card 27 or reads data stored in the memory card 27 at the time that the memory card 27 is connected thereto. In addition, the printing performing unit 22 is an ink jet type mechanism that performs a printing process of printing an image corresponding to the image data on a recording sheet by applying a pressure to each color ink and ejecting the pressed ink on the recording sheet. In addition, a mechanism that applies the pressure to the ink may be a mechanism using deformation of piezoelectric devices or a mechanism using occurrence of bubbles by heat of a heater. In addition, the scan performing unit 23 may be configured as a scanner mechanism that reads an original through scanning of a well-known color image sensor that decomposes reflected light beams from an illuminated document mounted on a glass plate into colors as read data.

The FAX apparatus 30 is an apparatus that is configured as a FAX that performs the printing contents transmission/reception in an audio scheme considered as one of digital FAX protocols. The FAX apparatus 30 is connected to the SIP proxy server 14 of the IP network 11 through an I/F (not shown). The FAX apparatus 30 includes a controller 31 that controls the entire apparatus, a printing performing unit 32 that prints text or image data, a scan performing unit 33 that scans text or images on a medium such as paper to obtain image data, a memory 34 that stores various programs executed by the controller 31, temporarily stores to-be-printed data, or temporarily stores the image data obtained by the scanning, and a manipulator 35 that displays various kinds of information to a user or receives various commands from the user as an input. In addition, the printing performing unit 32 is configured as a full-color electro-photographic type printing apparatus using a signal photoreceptor type or an intermediate transferring type, wherein electrostatic latent image of each color image is developed as a toner image and the toner image is transferred to a recording sheet and heated to be fused thereon. The scan performing unit 33 may be configured as a scanner mechanism that reads an original through scanning of a well-known color image sensor that decomposes reflected light beams from an illuminated document into colors as read data.

The FAX apparatus 40 is an apparatus that is configured a G3-adapted FAX that performs the printing contents transmission/reception in a T.30 scheme recommended by ITU-T (International Telecommunication Union Telecommunication Standardization Sector) as one of analog FAX protocols. The FAX apparatus 40 is connected to the converter 70 with a telephone line through an I/F (not shown). The elements of the FAX apparatus 40 are the same as those of the FAX apparatus 30. Therefore, the elements of the FAX apparatus 40 are denoted by reference numerals that are obtained by affixing 10 to the reference numerals of the elements of the FAX apparatus 30, and the description thereof is omitted.

The HGW 60 is an apparatus that is disposed between the converter 70 and the IP network 11 and has a function as a router as well as a function of performing protocol conversion between the T.30 scheme and the considered audio scheme. The HGW 60 includes a controller 61 that controls the entire apparatus, a memory 64 that stores various programs executed by the controller 61 or temporarily stores data, and I/Fs 65, 66, and 67. The HGW 60 is connected to the SIP proxy server 16 of the IP network 11 through the I/F 65. In addition, the HGW 60 is connected to the converter 70 with a LAN cable through the I/F 66. In addition, the HGW 60 is connected to the converter 70 with a telephone line through the I/F 67. If the HGW 60 receives data in a format used in the T.30 scheme from the FAX apparatus 40 through the I/F 67 and the converter 70, the HGW 60 functions as a VoIP (Voice over Internet Protocol) gateway. In other words, the FAX apparatus 40 is allowed to convert an analog signal in a communicable T.30 scheme into an IP packet in an audio scheme considered as one of FAX protocols used in the IP network 11 vice verse and to transmit the printing contents to a terminal (for example, FAX apparatus 30) of receiving the printing contents in a considered audio scheme from the FAX apparatus 40 through the IP network 11. In addition, if the HGW 60 receives data in a format used in the HTTP through the I/F 66 or the I/F 65, the HGW 60 performs an HTTP relaying process of relaying the received data without change. Therefore, the data in a format used in the HTTP through the I/F 66 are transmitted through the I/F 65 without change. The data in a format used in the HTTP through the I/F 65 are transmitted through the I/F 66 without change.

The converter 70 is an apparatus that is disposed between the FAX apparatus 40 and the HGW 60 and has a function of performing protocol conversion between the T.30 scheme and the HTTP. The converter 70 includes a controller 71 that controls the entire apparatus, a memory 74 that stores various programs executed by the controller 71 or temporarily stores data, and I/Fs 75, 76, and 77. The converter 70 is connected to the FAX apparatus 40 with a telephone line through the I/F 75. The converter 70 is connected to the I/F 66 of the HGW 60 with a LAN cable through an I/F 76. The converter 70 is connected to the I/F 67 of the HGW 60 with a telephone line through an I/F 77. The converter 70 converts data in a format used in the T.30 scheme, which are received from the FAX apparatus 40 through the I/F 75, into data in a format used in HTTP and transmits the converted data to the HGW 60 through the I/F 76. In addition, the converter 70 may transmit the received data without change to the HGW 60 through the I/F 77. In addition, as described later in detail, the memory 74 includes identification information storage area 74a that stores identification information of the apparatus, of which the connection establishment according to the format used in the HTTP is an impossible task.

Next, the operations of the converter 70 having the aforementioned configuration according to the embodiment, particularly, the operations of the converter 70, at the time of transmitting the printing contents from the FAX apparatus 40 to the multifunctional apparatus 20 or the FAX apparatus 30, are described.

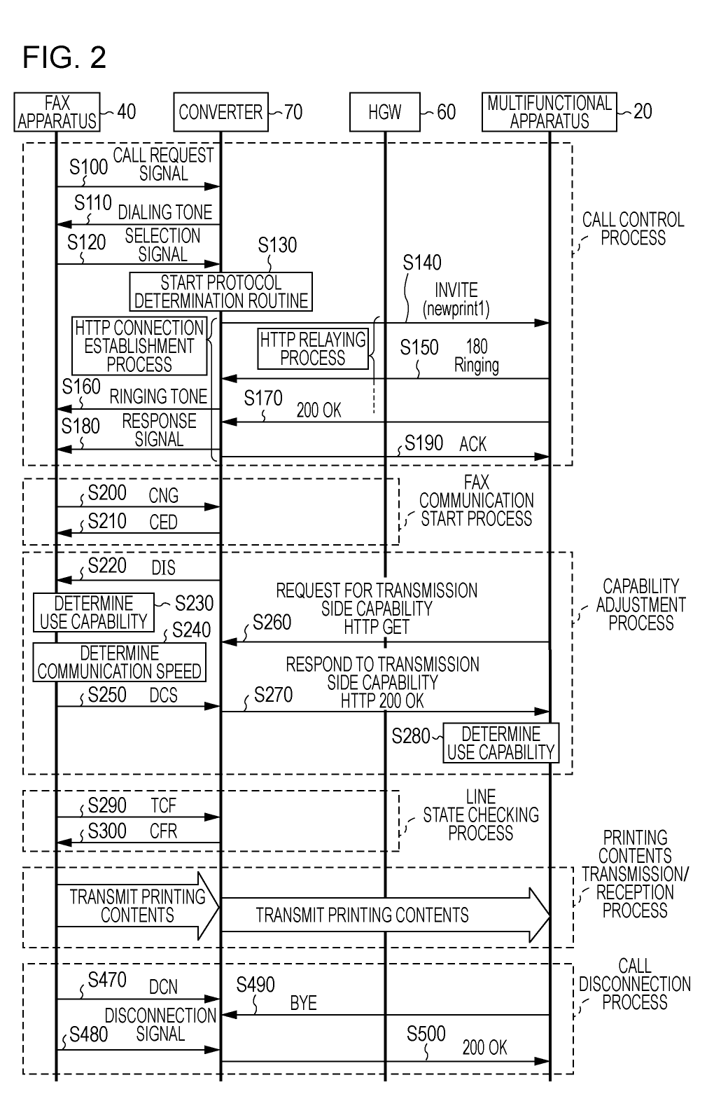

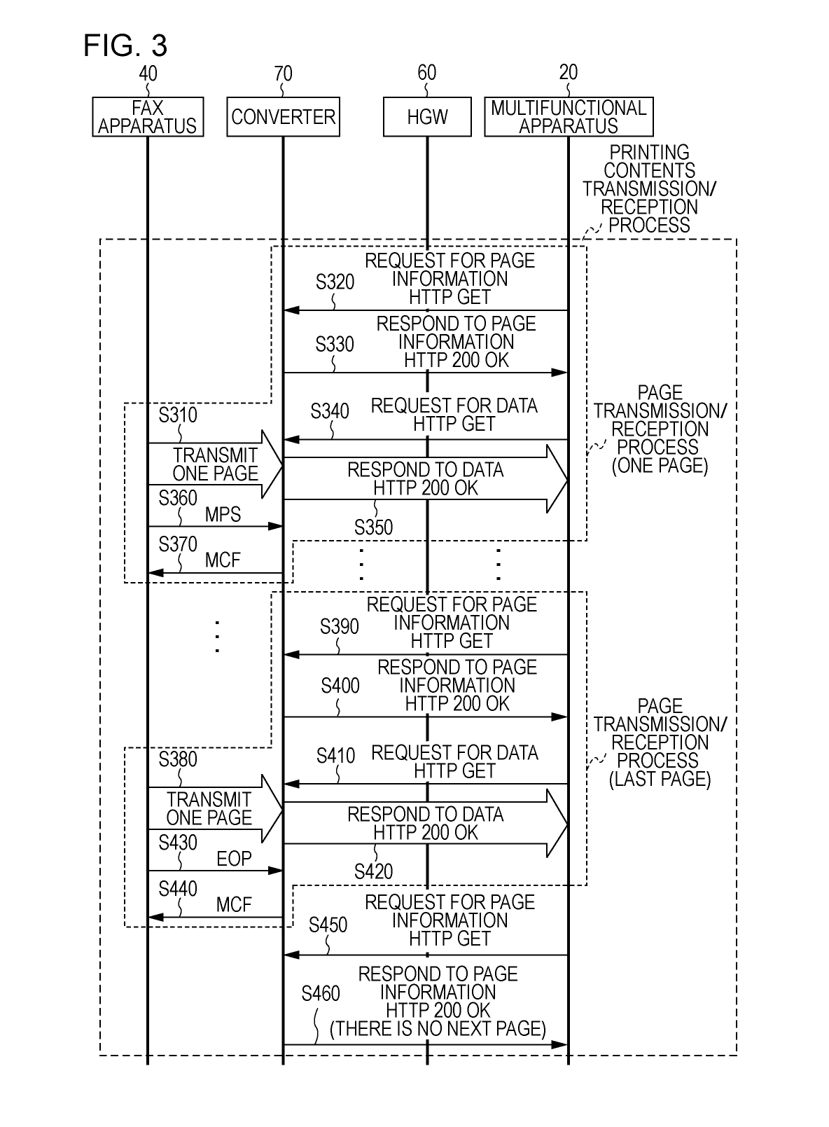

First, the operations of the converter 70, at the time of initially transmitting the printing contents from the FAX apparatus 40 to the multifunctional apparatus 20, are described. FIG. 2 is a view illustrating sequences of the FAX apparatus 40 and the multifunctional apparatus 20 from the time that the FAX apparatus 40 and the multifunctional apparatus 20 establish connection through the connector 70 and the HGW 60 to perform the printing contents transmission/reception to the time that the FAX apparatus 40 and the multifunctional apparatus 20 cut off connection. FIG. 3 is a detailed view illustrating sequences of a printing contents transmission/reception process for actually performing the printing contents transmission/reception among the sequences of FIG. 2. In addition, although the SIP proxy servers 12 and 16 are not shown in FIGS. 2 and 3, in actual cases, the HGW 60 and the multifunctional apparatus 20 receives and transmits data through the SIP proxy servers 12 and 16 of the IP network 11.

The transmission of the printing contents from the FAX apparatus 40 to the multifunctional apparatus 20 starts when a user of the FAX apparatus 40 sets a document, on which to-be-transmitted printing contents are written, on the scan performing unit 43, inputs identification information (for example, a serial number) uniquely allocated to the multifunctional apparatus 20 as a destination by manipulating the manipulator 45, presses a transmission button (not shown). If the user presses the transmission button, in order to transmit the printing contents to the multifunctional apparatus 20 allocated with the identification information input by the user, the controller 41 of the FAX apparatus 40 first transmits a call request signal to the converter 70 as a call control process for establishing the connection to the multifunctional apparatus 20 (Step S100). The controller 71 of the converter 70 receiving the call request signal transmits a dialing tone (dial tone) to the FAX apparatus 40 (Step S110). The controller 71 receives a selection signal transmitted by the controller 41 of the FAX apparatus 40 receiving the dialing tone (Step S120). The selection signal includes the identification information of the destination input by the user, that is, the identification information unique to the multifunctional apparatus 20.

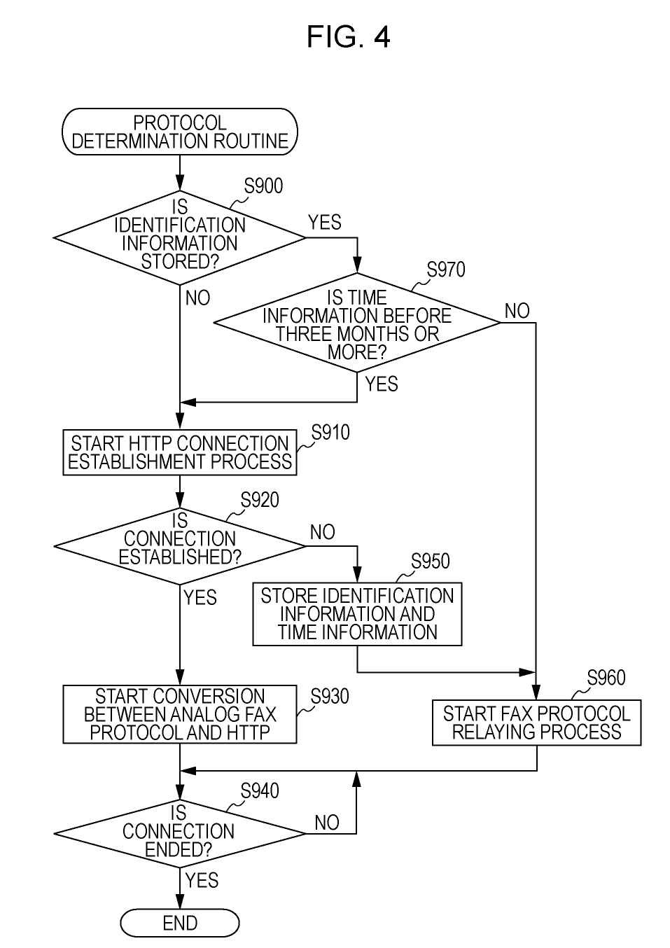

The controller 71 of the converter 70 that receives the selection signal starts a protocol determination routine of determining whether or not the apparatus of the destination, to which the FAX apparatus 40 transmits the printing contents, is an apparatus which can receive and print the printing contents in one of the HTTP and the considered audio scheme (Step S130). FIG. 4 is a flowchart illustrating an example of the protocol determination routine. Hereinafter, the protocol determination routine of FIG. 4 is described appropriately with reference to the sequences of FIG. 2.

If the protocol determination routine of FIG. 4 starts, the controller 71 first determines whether the identification information included in the selection signal received in Step S120 is stored as the identification information of the apparatus, of which connection establishment cannot be obtained in the format used in the HTTP, in the identification information storage area 74a of the memory 74 (Step S900). Herein, the memory 74 is configured to store the identification information of the apparatus, of which the connection establishment cannot be obtained in the format used in the HTTP in the later described process, in the identification information storage area 74a. Therefore, according to whether or not the identification information included in the selection signal received in Step S120 is stored in the identification information storage area 74a, it is determined whether or not the connection establishment of the apparatus specified by the identification information cannot be obtained in the format used in the HTTP. Herein, since the case where the FAX apparatus 40 initially transmits the printing contents to the multifunctional apparatus 20 is considered and since the identification information of the multifunctional apparatus 20 is not stored in the identification information storage area 74a, negative determination is made in Step S900.

If the negative determination is made in Step S900, the controller 71 starts the HTTP connection establishment process (Step S910) and determines whether or not to establish the connection (Step S920). The HTTP connection establishment process is a process for performing the connection establishment between the FAX apparatus 40 and the multifunctional apparatus 20 by performing data transmission/reception in the T.30 scheme with respect to the FAX apparatus 40 through the I/F 75 and by performing data transmission/reception in the format used in the HTTP with respect to the multifunctional apparatus 20 specified by the identification information through the I/F 76, the HGW 60, and the IP network 11. First, as the HTTP connection establishment process, the controller 71 transmits an INVITE message to the multifunctional apparatus 20 through the I/F 76, the HGW 60, and the IP network 11 in order to establish the session according to the SIP, that is, a format used in the HTTP with respect to the multifunctional apparatus 20 (Step S140) (refer to FIG. 2).

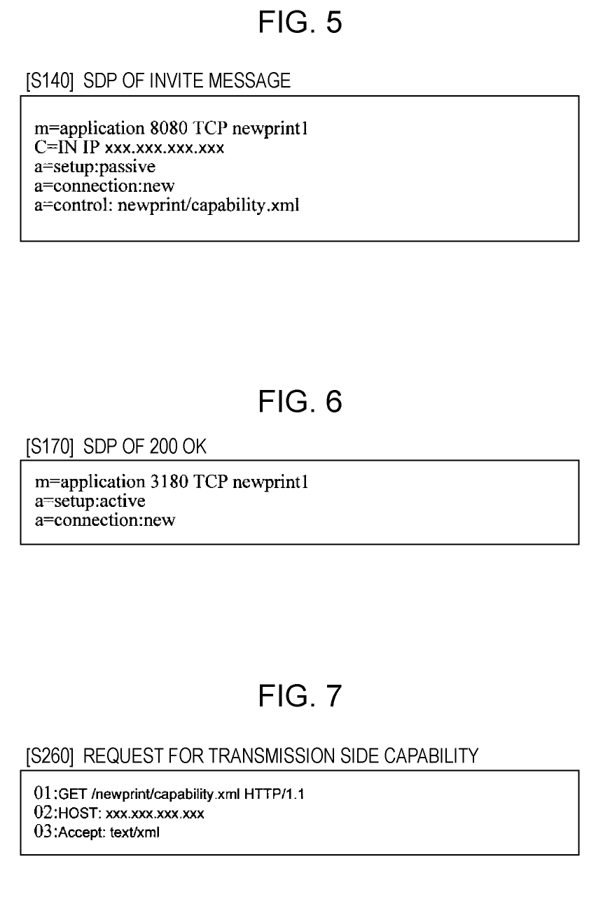

FIG. 5 illustrates an example of contents of SDP (Session Description Protocol) in an INVITE message that the converter 70 transmits in Step S140. The SDP of FIG. 5 constitutes a media description portion. In the SDP, the line “m=” represents information of a media type or a transport address. In FIG. 5, the line “m=” denotes that an application defined by a payload type “newprint1” using “TCP (Transmission Control Protocol)” is treated as the port number “8080”. Herein, in the line “m=”, the description “newprint1” functions as identifying the inclusion of the transmission and reception of the printing contents data according to the HTTP. Therefore, in the description “newprint1”, a terminal that transmits the printing contents functions as a server in a server-client model, and a terminal that receives the printing contents function as a client in the server-client model, so that the printing contents transmission/reception according to the HTTP is performed. It can be understood from “a=setup:passive” of FIG. 5 that the converter 70 that is a terminal of the transmission side functions as a “passive side” (server). In the SDP, the line “C=” represents the address of the media included in the session. It can be understood from the description “IN IP xxx.xxx.xxx.xxx” in the line “C=” of FIG. 5, the IP address of the converter 70 of the transmission side is “xxx.xxx.xxx.xxx”. In addition, the description “newprint/capability.xml” in the last line “a=” of FIG. 5 represents a URL of the initial request site of the terminal that receives the printing contents after the session establishment. Due to the description, the terminal of the reception side that functions as the client in the server-client model can acquire the URL of the capability request initially requested to the converter 70. In addition, although not shown, the identification information unique to the aforementioned multifunctional apparatus 20 as the information of specifying the transmission site is described in the header of the INVITE message that is transmitted by the converter 70.

In addition, the INVITE message transmitted through the I/F 76 of the converter 70 is first received through the I/F 66 by the HGW 60. Herein, as described above, the HGW 60 performs the HTTP relaying process of transmitting the data in the format used for the HTTP, which are received through the I/F 66, to the IP network 11 through the I/F 65 without change. Therefore, the INVITE message is also transmitted to the SIP proxy server 16 of the IP network 11 without change. Next, if the INVITE message is received, the SIP proxy server 16 specifies the URI of the multifunctional apparatus 20 based on the identification information unique to the multifunctional apparatus 20 described in the header of the INVITE message and transmits he INVITE message based on the URI to the SIP proxy server 12, and the SIP proxy server 12 also specifies the URI of the multifunctional apparatus 20 and transmits the INVITE message to the multifunctional apparatus 20, so that the INVITE message is received by the multifunctional apparatus 20. In addition, the specifying of the URI of the multifunctional apparatus 20 based on the identification information unique to the multifunctional apparatus 20 can be performed, for example, by transmitting the identification information to the location server of the IP network 11 and acquiring the corresponding URI.

Since the multifunctional apparatus 20 is an apparatus capable of transmitting and receiving the printing contents according to the HTTP as described above, if the multifunctional apparatus 20 received the INVITE message in Step S140, the controller 21 transmits the “180 Ringing” to the converter 70 as a state code indicating the on-calling state as a response so that the session of the SIP can be established (Step S150). In addition, at this time, similarly to the time of transmitting the INVITE message, the SIP proxy servers 12 and 16 specifies the URI of the converter 70 based on the identification information unique to the converter 70 (the IP address of the converter 70 included in the INVITE message) described in the header of the “180 Ringing” and transmits the “180 Ringing” to the HGW 60, and the HGW 60 performs the HTTP relaying process of relaying the “180 Ringing” to the converter 70. The data relaying in the SIP proxy servers 12 and 16 and HGW 60 is the same as that of the following processes, and thus, the description thereof is omitted hereinafter.

Subsequently, the controller 71 of the converter 70 that receives the “180 Ringing” transmits the ringing tone to the ringing tone indicating the on-ringing state FAX apparatus 40 (Step S160). On the other hand, if the “180 Ringing” in Step S150 is transmitted, the controller 21 of the multifunctional apparatus 20 performs the preparation of the session establishment, and after that, transmits to the converter 70 the “200 OK” as a state code indicating the success of the ringing for the session establishment (Step S170).

FIG. 6 is a view illustrating an example of contents of the SDP in the message “200 OK” transmitted by the multifunctional apparatus 20 in Step S170. In FIG. 6 the line “m=” denotes that an application defined by a payload type “newprint1” using “TCP” is treated as the port number “3180”. In addition, it can be understood from the “newprint1” and “a=setup:active” of FIG. 6 that the printing contents reception side (in this case, the multifunctional apparatus 20) functions as the “active side” (client) to perform the printing contents transmission/reception according to the HTTP.

Next, the controller 71 of the converter 70 that receives the “200 OK” transmits a response signal to the FAX apparatus 40 (Step S180) and transmits to the multifunctional apparatus 20 the “ACK” as a state code of the reception acknowledgement of the final response to the INVITE message (Step S190). Due to the aforementioned Steps S140 to S190, the connection establishment is obtained by the HTTP connection establishment process, and the call control process of the Steps S100 to S190 is ended. Herein, if the “200 OK” in Step S170 is received from the multifunctional apparatus 20, the controller 71 of the converter 70 considers the connection establishment according to the HTTP connection establishment process to be obtained, so that an affirmative determination is made in Step S920 of the protocol determination routine shown in FIG. 4.

If the affirmative determination is made in Step S920, the controller 71 considers the multifunctional apparatus 20 that performs the connection establishment to be an apparatus for receiving the printing contents according to the HTTP and performing printing. Next, the controller 71 starts the protocol conversion between the T.30 scheme and the HTTP so that the printing contents are transmitted to the multifunctional apparatus 20, which receives the printing contents according to the HTTP from the FAX apparatus 40 for transmitting the printing contents in the T.30 scheme and prints the printing contents (Step S930). The controller 71 performs a FAX communication start process, a capability adjustment process, a line state checking process, a printing contents transmission/reception process, and a call disconnection process described later, and waits until the connection is ended (Step S940).

After the protocol conversion starts in Step S930, the controller 71 first receives the “CNG (calling tone)”, which is transmitted by the FAX apparatus 40, from the FAX apparatus 40 as the FAX communication start process of performing the preparation of the FAX communication (Step S200) (refer to FIG. 2). The “CNG” is a signal requesting for starting of the FAX communication. Next, the controller 71 of the converter 70 that receives the “CNG” transmits to the FAX apparatus 40 the “CED (called terminal identification)” informing that the FAX communication can start (Step S210). The FAX communication start process of the aforementioned Steps S200 to S210 is a process defined in the T.30 scheme, which is generally performed by the terminal of the transmission side transmitting the “CNG” and the terminal of the reception side transmitting the “CED” as a response. Since the multifunctional apparatus 20 is an apparatuses for performing the printing contents transmission/reception according the HTTP but not performing the FAX communication start process, the converter 70 receives the “CNG” and transmits the “CED”. Due to the FAX communication start process, the FAX apparatus 40 prepares for the performing of the FAX communication.

If the FAX communication start process is ended, the controller 71 of the converter 70 first transmits to the FAX apparatus 40 the “DIS (digital identification signal)” including information on the reception side temporary capability as a capability of a terminal of the reception side of receiving and printing the printing contents or information on a temporary communication speed as a communication speed of the terminal of the reception side as a capability adjustment process for adjusting the capability used for the current printing contents transmission/reception (Step S220). The “DIS” is 64-bit information. The reception side temporary capability information includes a size of receivable and printable image data, a resolution of the image data, encode types of generating tiff or jpeg printing contents, color types such as color or monochrome, or the like. Herein, as the capability represented by the reception side temporary capability information, the size of the image data is A4 or B5; the resolution is 200×200 dpi; the encode type is tiff; and the color type is color or monochrome. The communication speed represented by the temporary communication speed information is 14.4 kbits/second. In addition, the reception side temporary capability information and the temporary communication speed information are stored in advance in the memory 74.

If the FAX apparatus 40 receives the “DIS” of Step S310, the controller 41 determines the use capability used for the current printing contents transmission/reception within a range of the transmission side capability, that is, the printing contents transmission capability of the FAX apparatus 40 and within a range of the capability represented by the reception side temporary capability information included in the “DIS” (Step S230). More specifically, the maximum capability included in both of the transmission side capability and the reception side temporary capability is determined as the use capability. In the embodiment, as the transmission side capability of the FAX apparatus 40, the size of the image data is A4 or B5; the resolution is 200×200 dpi; the encode type is tiff; and the color type is color or monochrome. Therefore, the size of the image data of A4, the resolution of 200×200 dpi, the encode type of tiff, and the color type of color are determined as the use capability. In addition, for example, if the color type of the transmission capability of the FAX apparatus 40 is monochrome, the transmission side capability is monochrome, and the reception side temporary capability is color or monochrome. Therefore, the maximum capability included in both thereof is monochrome, which is determined as the use capability. Subsequently, the controller 41 determines the communication speed used for the current printing contents transmission/reception within a range of the communication speed of the FAX apparatus 40 and within the communication speed represented by the temporary communication speed information included in the “DIS” (Step S240). In the embodiment, the communication speed of the FAX apparatus 40 is 9.6 kbits/second. Therefore, by comparing the 9.6 kbits/second with 14.4 kbits/second represented by the temporary communication speed information, the 9.6 kbits/second is determined as the currently-used communication speed.

If the use capability and the used communication speed are determined, the controller 41 transmits to the converter 70 the “DCS (digital command signal)” including the use capability information representing the use capability and the communication speed information representing the determined communication speed and notifies the determined use capability and communication speed (Step S250). Accordingly, the converter 70 can check the capability and communication speed that are used by the FAX apparatus 40 for the current printing contents transmission/reception.

On the other hand, if the call control process is ended, the controller 21 of the multifunctional apparatus 20 transmits a transmission side capability request to the converter 70 a transmission adjustment process (Step S260). The transmission side capability request is a request for transmitting the multifunctional apparatus 20 the transmission side capability information representing the printing contents transmission capability of the terminal of the transmission side. FIG. 7 is a view illustrating an example of contents of the transmission side capability request. A command “GET” representing the “request” and a URL “newprint/capability.xml” of the initial request site described in the INVITE message received from the converter 70 in Step S140 are described in the line 01 of the transmission side capability request. In addition, the line 02 describes an IP address of the converter 70 that is obtained from the INVITE message received from the converter 70 in Step S140, and the line 03 describes that an XML text is received. In addition, since the transmission of the transmission side capability request in Step S260 can be performed after the call control process is ended, for example, the multifunctional apparatus 20 may perform the process of Step S260 during the time when the FAX communication start process is performed.

Next, if the converter 70 receives the “DCS” of Step S250 and the transmission side capability request of Step S260, the controller 71 sets the capability represented by the use capability information included in “DCS” to the transmission side capability and transmits a transmission side capability response including the transmission side capability information representing the transmission side capability to the multifunctional apparatus 20 (Step S270).

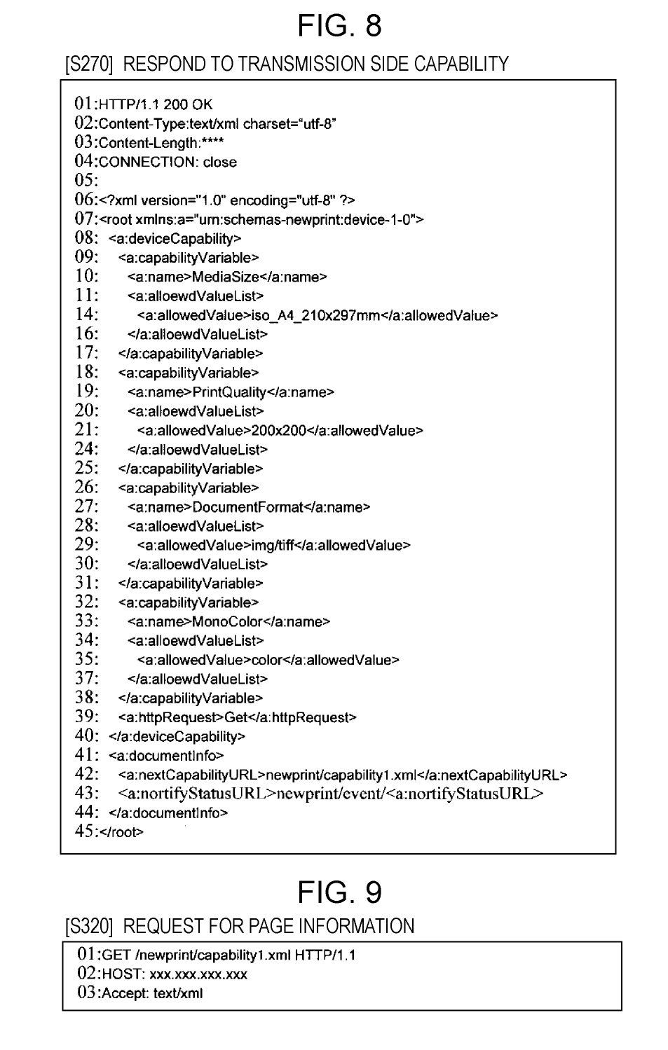

FIG. 8 is view illustrating an example of the transmission side capability response. The line 01 of the transmission side capability response describes “200 OK” indicating the success with respect to the request; the line 02 describes that the type of the contents is an XML text; and the line 03 describes a length. In addition, the transmission side capability information is described in the lines 08 to 40. It can be understood from this example that the size of the transmittable image (“MediaSize” in the line 10) is A4 (line 14), the resolution (“PrintQuality” in the line 19) is 200×200 dpi (line 21), the encode type (“DocumentFormat” in the line 27) is tiff (“img/tiff” in the line 29), and the color type (“MonoColor” in the line 33) is color (line 35) In other words, the capability represented by the use capability information received in Step S250 is transmitted to the multifunctional apparatus 20 without change as the transmission side capability. In addition, the URL (“newprint/capability1.xml”) at the time of requesting the page information from the reception side of the next printing contents is described in the line 42 of the transmission side capability response. The URL is a relative address with respect to the IP address “xxx.xxx.xxx.xxx” (“HOST:xxx.xxx.xxx.xxx” of the line 02 in FIG. 7) of the converter 70, which is described through the SDP in the INVITE message that is transmitted from the controller 71 in Step S140. In addition, a URL (“newprint/event/”) for receiving status changing information is described in the line 43. The URL for receiving the status changing information is a URL, through which the converter 70 receives information from the multifunctional apparatus 20 when the reception side of the printing contents is not in the normal state, for example, when paper jam occurs at the time of printing the received printing contents.

If the multifunctional apparatus 20 receives the transmission side capability response of Step S270, the controller 21 determines the use capability used for the current printing contents transmission/reception within a range of the transmission side capability represented by the transmission side capability information included in the transmission side capability response and within a range of the reception side capability, that is, the printing contents receiving/printing capability of the multifunctional apparatus 20 (Step S280). In the embodiment, as the reception side capability of the multifunctional apparatus 20, the size of the image is A3, B4, A4, or B5; the resolution is 200×200 dpi, 300×300 dpi, or 400×400 dpi; and the encode type is tiff; and the color type is color or monochrome. Therefore, the reception side capability of the multifunctional apparatus 20 is equal to or more than the transmission side capability represented by the transmission side capability information included in the transmission side capability response, and the controller 21 determines the transmission side capability as the use capability without change.

Through the aforementioned Steps S220 to S280, the capability adjustment process is ended. Herein, in the T.30 scheme, the terminal of the reception side transmits the reception side capability information, and the terminal of the transmission side determines the use capability and notifies the use capability to the terminal of the reception side. On the other hand, when the printing contents transmission/reception according to the HTTP defined by the “newprint1” is performed, since the terminal of the reception side functions as the client in the server-client model, the terminal of the reception side performs the transmission side capability request to acquire the transmission side capability information, so that the terminal of the reception side determines the use capability. Therefore, in the case where the FAX apparatus 40 is a terminal of the transmission side and the multifunctional apparatus 20 is a terminal of the reception side, each of the FAX apparatus 40 and the multifunctional apparatus 20 acquires the capability of the counter party to determine the use capability. In addition, the converter 70 first transmits to the FAX apparatus 40 the reception side temporary capability, which is stored in the memory 74 in advance, so that the FAX apparatus 40 also determines the use capability. Next, the converter 70 receives the determined use capability from the FAX apparatus 40 and transmits the use capability as the transmission side capability to the multifunctional apparatus 20, so that the multifunctional apparatus 20 also determines the use capability. Accordingly, all the protocols for the FAX apparatus 40 and the multifunctional apparatus 20 can be satisfied. In addition, the converter 70 stores the capability equal to or less than the reception side capability of the multifunctional apparatus 20 as the reception side temporary capability in the memory 74 in advance. For example, the lowest capability of a general multifunctional apparatus may be stored as the reception side temporary capability, and the identification information unique to the multifunctional apparatus 20 and the reception side capability of the multifunctional apparatus 20 may be stored in the memory 74 in a correspondence manner. In this manner, since the use capability determined by the FAX apparatus 40 is within the transmission side capability of the multifunctional apparatus 20, the use capability determined by the FAX apparatus 40 in Step S230 can be the same as the use capability determined by the multifunctional apparatus 20 in Step S280. In addition, in the T.30 scheme, the terminal of the reception side may also transmit the communication speed information of the reception side as well as the reception side capability information, so that the terminal of the transmission side can also determine the communication speed of the printing contents transmission/reception. However, in the HTTP defined by the “newprint1”, since the determination of the communication speed is not performed, the converter 70 transmits the temporary communication speed information, which is stored in the memory 74 in advance, included in the “DIS” to the FAX apparatus 40 in Step S220, so that the currently-used communication speed is determined by the FAX apparatus 40. The communication speed represented by the temporary communication speed information may be equal to the communication speed of a general FAX apparatus. Alternatively, the communication speed represented by the temporary communication speed information may be the highest communication speed among general FAX apparatuses so that the highest communication speed of the terminal of the transmission side is determined to be the currently-used communication speed.

If the aforementioned capability adjustment process is ended, the controller 41 of the FAX apparatus 40 first transmits to the converter 70 a training signal “TCF (training check)” at the currently-used communication speed determined in Step S240 as the line state checking process for checking the state of the communication line between the FAX apparatus 40 and the converter 70 (Step S290). Next, if there is no 1-bit error in the received “TCF”, the controller 71 of the converter 70 transmits to the FAX apparatus 40 a signal “CFR (confirmation to receive)” indicating that there is no error (Step S300). Through the line state checking process of Steps S290 to S300, it can be checked that the communication can be performed at the communication speed notified in Step S250, and the printing contents transmission/reception hereinafter is determined to be performed at this communication speed. The line state checking process is a process defined in the T.30 scheme, which is generally performed between the terminal of the transmission side and the terminal of the reception side. The multifunctional apparatus 20 is an apparatus that performs the printing contents transmission/reception according to the HTTP. Since the line state checking process is not performed, the converter 70 performs the reception of the “TCF” or the transmission of the “CFR” as the terminal of the reception side. In addition, although not shown in FIG. 2, when there is an error in the “TCF” received by the converter 70 in Step S290, the controller 71 transmits to the FAX apparatus 40 a signal “FTT (failure to train)” indicating that there is an error, and the controller 41 of the FAX apparatus 40 re-transmits to the “TCF” to the converter 70 at the communication speed that is lowered by one step. Next, the transmission/reception of the “TCF” and the “FTT” are repeated at the communication speed that is lowered step by step, and the communication speed at the time of receiving the “CFR” from the converter 70 is determined as the currently-used communication speed.

If the line state checking process is ended, the controller 41 of the FAX apparatus 40 generates the one-page printing contents data in the format used for the T.30 scheme and the use capability determined in Step S230 and transmits to the converter 70 the one-page printing contents data at the communication speed determined in the line state checking process as the printing contents transmission/reception process for transmitting the printing contents from the FAX apparatus 40 to the multifunctional apparatus 20 (Step S310) (refer to FIG. 3). In addition, the one-page printing contents data are generated by allowing the scan performing unit 43 to read the one page of the document set by a user of the FAX apparatus 40 before the call control process, and the printing contents data are sequentially transmitted as HDLC (high level data link control) frames in the format used for the T.30 scheme. The converter 70 sequentially receives the printing contents data from the FAX apparatus 40 and stores the printing contents data in the memory 74.

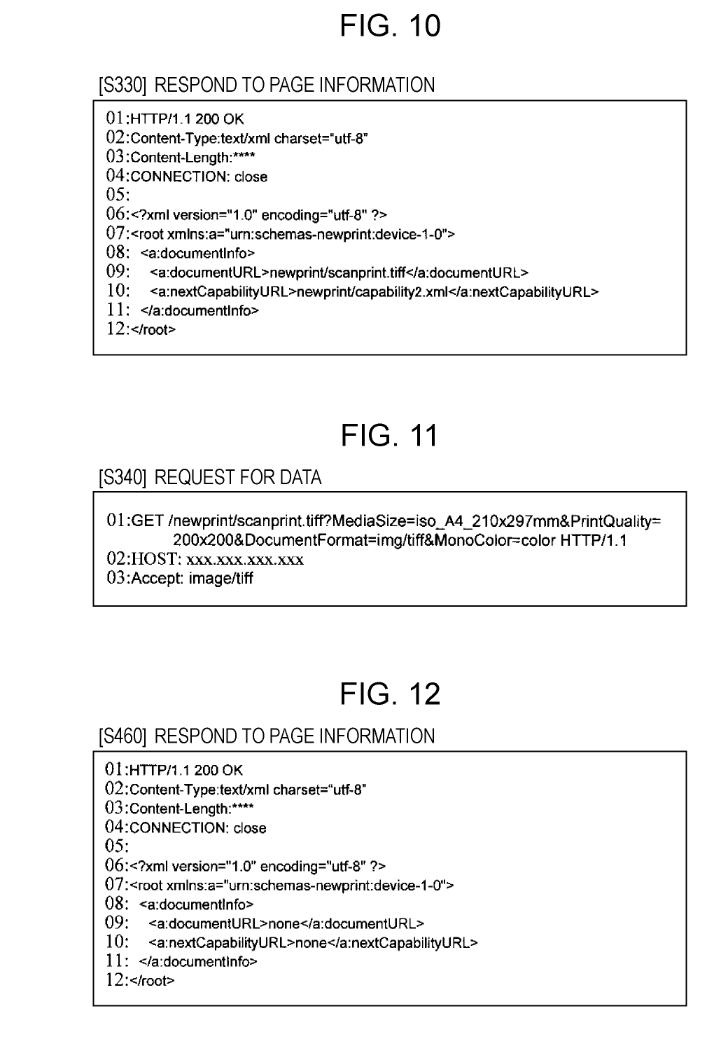

On the other hand, if the capability adjustment process is ended, the controller 21 of the multifunctional apparatus 20 transmits the page information request to the converter 70 by using the URL (“newprint/capability1.xml” in the line 42 of FIG. 8) described in the transmission side capability response of Step S270 as the printing contents transmission/reception process (Step S320). Next, the controller 71 of the converter 70 that receives the page information request transmits the page information response to the multifunctional apparatus 20 (Step S330). An example of the page information request is illustrated in FIG. 9. It can be understood that the “newprint/capability1.xml” described in the line 01 of the page information request is the same as the “newprint/capability1.xml” described in the line 42 of the capability response of FIG. 8. An example of the page information response is illustrated in FIG. 10. It can be understood that the URL “newprint/scanprint.tiff” of one page of the printing contents data is described in the line 09 of the page information response, and the URL “newprint/capability2.xml” of the next page in the printing contents is described in the line 10 thereof. When the page information response is received from the converter 70, if there is a URL of the printing contents data in the page information response or a URL of the next page in the printing contents, the controller 21 of the multifunctional apparatus 20 acquires the URLs.

Subsequently, the controller 21 of the multifunctional apparatus 20 transmits to the converter 70 the data request so as to request for transmitting the printing contents data by using the URL (“newprint/scanprint.tiff” of the line 09 of the page information response in FIG. 10) described in the line 09 of the page information response received in Step S330 (Step S340).

An example of the data request is illustrated in FIG. 11. It can be understood that the “newprint/scanprint.tiff” described in the line 01 of the data request is the same as the “newprint/scanprint.tiff” described in the line 09 of the page information response of FIG. 10. In addition, the data request is associated with the notification of the use capability determined by the controller 21 in Step S280 of the capability adjustment process. More specifically, in the description of the line 01 of the data request in FIG. 11, “MediaSize=iso_A4_{—}210×297 mm” represents that the size of the image data is A4; “PrintQuality=200×200” represents that the resolution is 200×200 dpi; “DocumentFormat=img/tiff” represents that the encode type is tiff; and “MonoColor=color” represents that the color type is color. By transmitting the data request, the multifunctional apparatus 20 requests the converter 70 to transmits the printing contents data as the determined use capability.

Next, the controller 71 of the converter 70 that receives the data request of Step S340 generates the data response including the data that are obtained by converting the printing contents data, which are received and stored in the memory 74 in Step S310, into the data in the format used for the HTTP and transmits the data response to the multifunctional apparatus 20 (Step S350). In addition, the printing contents data that are received by the converter 70 in Step S310 are sequentially transmitted from the FAX apparatus 40 in a state where the data are divided into HDLC frames in the format used for the T.30 scheme. Therefore, the controller 71 performs the process of receiving all the one-page printing contents data and storing the data in the memory 74 and the process of Step S350 of converting the sequentially-stored printing contents data into the IP packets in the format used for the HTTP to generate the data response and transmitting the data response to the multifunctional apparatus 20. Next, the controller 21 of the multifunctional apparatus 20 receives the data response of Step S350 and stores the printing contents data included in the data response in the memory 24. In addition, the controller 21 of the multifunctional apparatus 20 controls the printing performing unit 22 to print the printing contents data stored in the memory 24.

On the other hand, if the transmission of the one-page printing contents data is completely ended in Step S310, and if it is determined that there is the next page of the printing contents data, the controller 41 of the FAX apparatus 40 transmits to the converter 70 a signal “MPS (multi-page signal)” indicating that there is the next page (Step S360). In addition, the existence of the next page is determined, for example, according to whether or not there a document that is set on the scan performing unit 43 but not scanned. The controller 71 of the converter 70 that receives the “MPS” transmits to the FAX apparatus 40 a notice “MCF (message confirmation)” indicating that the reception of the printing contents data from the FAX apparatus 40 in Step S310 is completed (Step S370). In addition, the process of Step S370 may be performed after the process of Step S350 of generating the data response and transmitting the data response to the multifunctional apparatus 20 is completely ended.

Through the aforementioned Steps S310 to S370, the page transmission/reception process for transmitting the one-page printing contents data from the FAX apparatus 40 to the multifunctional apparatus 20 is ended. After that, until the transmission/reception of the one page before the last page of the printing contents is completed, the page transmission/reception process of the Steps S310 to S370 is repeated. In addition, the URL described in the line 01 of the page information request in Step S320 in the second or later page transmission/reception process is not the URL described in the transmission side capability response received in Step S270 but the URL of the next page of the printing contents described in the line 10 of the received newest page information response. Next, in the page transmission/reception process for the last page of the printing contents, although the process of Steps S380 to S420 shown in FIG. 3 are the same as that of Steps S310 to S350, if the transmission of the one-page printing contents data in Step S380 is completely ended, the controller 41 of the FAX apparatus 40 determines that there is no next page of the printing contents and transmits to the converter 70 a signal “EOP (end of procedure)” indicating that there is no next page (Step S430). Next, the controller 71 of the converter 70 that receives the “MPS” transmits to the FAX apparatus 40 the notice “MCF” indicating that the reception of the printing contents data from the FAX apparatus 40 in Step S380 is completed (Step S440). Through the aforementioned Steps S380 to S440, the page transmission/reception process for the last page is ended. However, since the existence of the next page of the printing contents data received in Step S420 is not notified, the multifunctional apparatus 20 transmits the page information request to the converter 70 similarly to Steps S320 and S390 (Step S450). Next, the controller 71 of the converter 70 that receives the page information request transmits to the multifunctional apparatus 20 the page information response indicating that there is no next page (Step S460). An example of the page information response is illustrated in FIG. 12. It can be understood from “none” in the line 09 and “none” in the line 10 of the page information response in FIG. 12 that there is neither URL of the printing contents data nor URL of the next page. Since the URL of the printing contents data is not described in the line 09 of the page information response, the controller 21 of the multifunctional apparatus 20 that receives the page information response determines that there is no next page.

Through the aforementioned Steps S310 to S460, the printing contents transmission/reception process is ended. Similarly to the capability adjustment process, in the printing contents transmission/reception process, the converter 70 functions as the terminal of the reception side in the T.30 scheme to receive the printing contents from the FAX apparatus 40, and the converter 70 also functions as the server in the server-client model to transmit the printing contents according to the HTTP to the multifunctional apparatus 20 as the client.

If the printing contents transmission/reception process is ended, the controller 41 of the FAX apparatus 40 transmits “DCN (disconnect)” notifying disconnection of communication to the converter 70 as a call disconnection process of ending the connection (Step S470). Next, the controller 41 transmits a disconnection signal to the converter 70 (Step S480). Accordingly, the connection between the FAX apparatus 40 and the converter 70 is ended. In addition, if the printing contents transmission/reception process is ended, the controller 21 of the multifunctional apparatus 20 transmits a state code “BYE” for ending the session to the converter 70 as a call disconnection process (Step S490). The converter 70 that receives the “BYE” transmits the “200 OK” to the multifunctional apparatus 20 (Step S500), so that the connection between the multifunctional apparatus 20 and the converter 70 is ended.

Next, if the disconnection signal in Step S480 is received, the controller 71 of the converter 70 considers the connection to be ended, so that an affirmative determination is made in Step S940 (refer to FIG. 4), and ends the protocol determination routine.

In addition, hereinbefore, although the operations of the converter 70, at the time of initially transmitting the printing contents from the FAX apparatus 40 to the multifunctional apparatus 20, are described, the same operations are performed in the second or later cases. In other words, in the protocol determination routine, as described above, a negative determination is made in Step S900, so that the HTTP connection establishment process of Step S910 is performed. If the connection is established, an affirmative determination is made in Step S920, so that the protocol conversion between the T.30 scheme and the HTTP starts in Step S930. Accordingly, the transmission of the printing contents is performed by the sequence as shown in FIGS. 2 and 3.

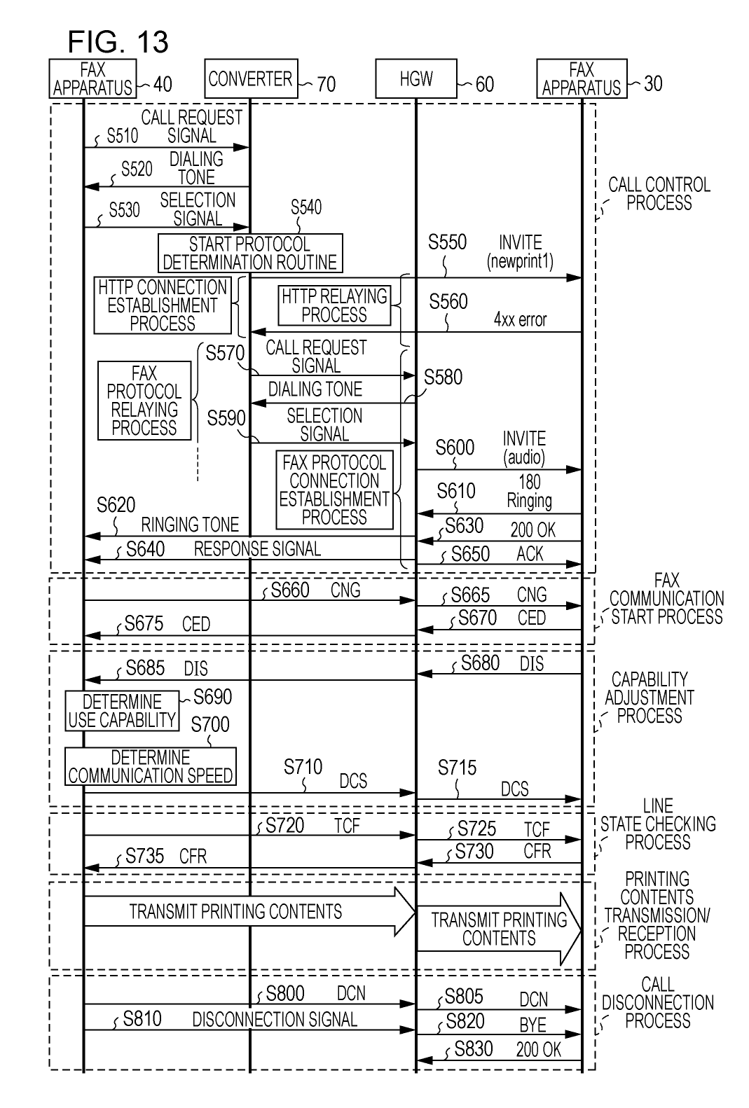

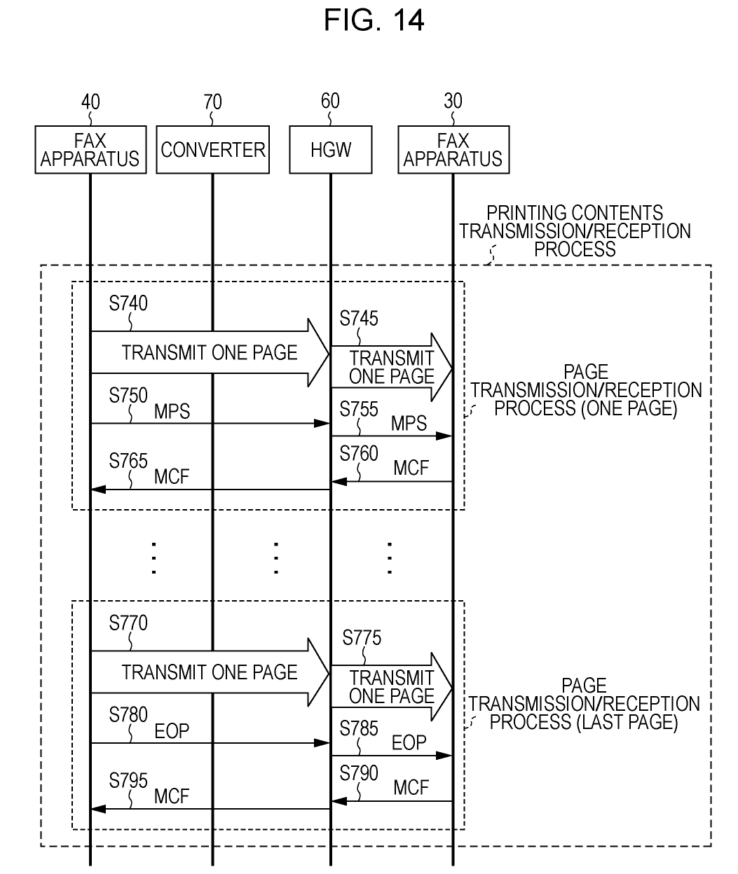

Next, the operations of the converter 70, at the time of initially transmitting the printing contents from the FAX apparatus 40 to the FAX apparatus 30, are described. FIG. 13 is a view illustrating sequences of the FAX apparatus 40 and the FAX apparatus 30 from the time that the FAX apparatus 40 and the FAX apparatus 30 establish connection through the converter 70 and the HGW 60 to receive and transmit printing contents to the time that the FAX apparatus 40 and the FAX apparatus 30 cut off connection. FIG. 14 is a detailed view illustrating sequences of a printing contents transmission/reception process for actually receiving and transmitting the printing contents among the sequences of FIG. 13. In addition, in FIGS. 13 and 14, the same description of the SIP proxy servers 14 and 16 as that of FIGS. 2 and 3 is omitted.

Similarly to the transmission to the multifunctional apparatus 20, the printing contents transmission from the FAX apparatus 40 to the FAX apparatus 30 starts by a user of the FAX apparatus 40 setting a document, on which to-be-transmitted printing contents are written, on the scan performing unit 43, inputting identification information (for example, a serial number) uniquely allocated to the FAX apparatus 30, that is, the transmission site through manipulation of the manipulator 45, and pushing a transmission button (not shown). Accordingly, the process that is the same as that of the aforementioned Steps S100 to S120 of FIG. 2 is performed between the FAX apparatus 40 and the converter 70 (Steps S510 to 530), and the controller 71 of the converter 70 that receives the selection signal of Step S530 starts the protocol determination routine that is the same as the aforementioned routine (Step S540).

Subsequently, the controller 71 performs the aforementioned determination of Step S900 of the protocol determination routine of FIG. 4. Since the FAX apparatus 40 initially transmits the printing contents to the FAX apparatus 30, the identification information of the FAX apparatus 30 is not stored in the identification information storage area 74a. The controller 71 makes a negative determination and starts the HTTP connection establishment process (Step S910) and determines whether or not to establish the connection (Step S920). Next, the controller 71 first transmits an INVITE message to the FAX apparatus 30 as the HTTP connection establishment process similarly to Step S140 of FIG. 2 (Step S550) (refer to 13).

If the FAX apparatus 30 receives the INVITE message, the controller 31 transmits a state code “4xxerror” denoting a request failure to the converter 70 as the transmission side (Step S560). As described above, since the “newprint1” is described in the line “m=” of the INVITE message received by the FAX apparatus 30, it is represented that the transmission side requests the FAX apparatus 30 to perform the printing contents transmission/reception according to the HTTP. However, since the FAX apparatus 30 performs the printing contents transmission/reception according to the considered audio scheme, the FAX apparatus 30 cannot respond to the request. Therefore, the FAX apparatus 30 transmits “4xxerror” with respect to the INVITE message where the “newprint1” is described in the line “m=” thereof.

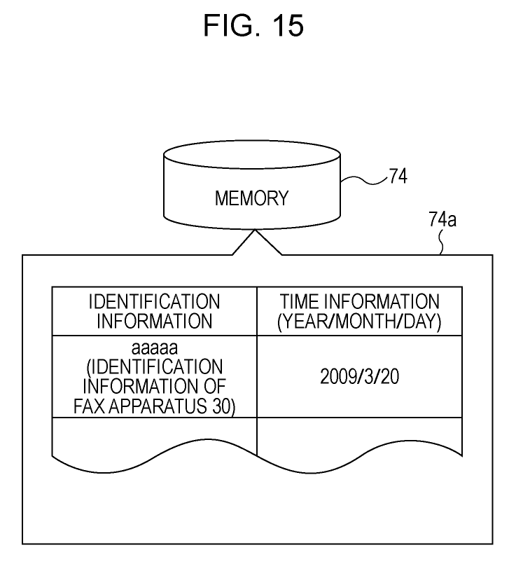

If the “4xxerror” is received, the controller 71 considers the connection establishment according to the HTTP connection establishment process not to be obtained, so that a negative determination is made in Step S920 of the protocol determination routine in FIG. 4. Next, the controller 71 stores the identification information included in the selection signal received in Step S530, that is, the identification information of the FAX apparatus 40, that is the terminal which tries to perform the HTTP connection establishment process in the identification information storage area 74a. In addition, the controller 71 stores time information indicating the storing time in correspondence with the identification information (Step S950). FIG. 15 is a view illustrating the identification information storage area 74a of the memory 74 at the time of storing the identification information of the FAX apparatus 30 and the time information in a correspondence manner in Step S950. As shown in the figure, the identification information of the FAX apparatus 40 and the time information indicating, for example, “2009/3/20” as the storing time of the identification information in Step S950 are stored in the identification information storage area 74a in a correspondence manner. In addition, in the embodiment, the time information represents the storing date of year/month/day. The storing date in a format of year/month/day is determined by an internal clock (not shown) included in the converter 70. In addition, the information correspondence stored in the identification information storage area 74a is not limited to the correspondence between the identification information of the FAX apparatus 40 and the time information shown in the figure, but a plurality of one-to-one correspondences between the identification information and the time information may be stored.

Subsequently, since a negative determination is made in Step S920, the controller 71 considers the apparatus that transmits the current printing contents to be an apparatus that receives and prints the printing contents according to not the HTTP but the considered audio scheme, starts the FAX protocol relaying process (Step S960), and waits until the process proceeds to Step S940 so that connection is ended. Herein, the FAX protocol relaying process is a process of transmitting to the HGW 60 the call request signal and selection signal received in Steps S510 and S530 without change through the I/F 77 in the format used in the T.30 scheme via a telephone line and a process of relaying the data transmitted and received by the FAX apparatus 40 and the HGW 60 without change through the I/Fs 75 and 77.

If the FAX protocol relaying process starts, the controller 71 first transmits to the HGW 60 the call request signal received in Step S510 without change through the I/F 77 in the format used for the T.30 scheme via the telephone line (Step S570). Since the INVITE message and “4xxerror” of Steps S550 and S560 are data in the format used for the HTTP, the controller 61 of the HGW 60 performs the HTTP relaying process. However, since the call request signal transmitted in Step S570 is data in the format used for the T.30 scheme, the controller 61 of the HGW 60 functions as a VoIP gateway for performing the protocol conversion between the T.30 scheme and the considered audio scheme to transmit to the converter 70 the same dialing tone as that in Step S510 (Step S580). Next, the controller 71 of the converter 70 that receives the dialing tone transmits to the HGW 60 the selection signal received in Step S520 without change through the I/F 77 in the format used for the T.30 scheme via the telephone line (Step S590). Next, the controller 71 continues to perform the process of relaying the data transmitted and received by the FAX apparatus 40 and the HGW 60 without change through the I/Fs 75 and 77 until the connection is determined to be ended in Step S940.

Next, the controller 61 of the HGW 60 that receives the selection signal performs the data transmission/reception with respect to the FAX apparatus 40 in the format used for the T.30 scheme through the I/F 67 In addition, the controller 61 of the HGW 60 performs the data transmission/reception with respect to the FAX apparatus 30 that is specified by the identification information included in the selected selection signal through the I/F 56 and the SIP proxy servers 16 and 14 in the format used for the considered audio scheme. Accordingly, the FAX protocol connection establishment process for performing the connection establishment between the FAX apparatus 40 and the FAX apparatus 30 starts. As the FAX protocol connection establishment process, the controller 61 first transmits to the FAX apparatus 30 the INVITE message in order to establish the session according to the SIP in the format used for the considered audio scheme with respect to the FAX apparatus 30 (Step S600). Unlike the INVITE message that is transmitted from the converter 70 in Step S550, not “newprint1” but “audio” is described in the line “m=” of the INVITE message. The description of the “audio” in the line “m=” functions as the identification that the printing contents transmission/reception according to the considered audio scheme is included.

Since the FAX apparatus 30 is an apparatus capable of performing the printing contents transmission/reception according to the considered audio scheme as described above, if the INVITE message where the “audio” is described in the line “m=” thereof is received, the controller 31 transmits to the HGW 60 the “180 Ringing” as a response so that the session according to the SIP is established (Step S610). Subsequently, the controller 61 of the HGW 60 that receives the “180 Ringing” transmits the ringing tone to the FAX apparatus 40 (Step S620). On the other hand, if the “180 Ringing” of Step S610 is transmitted, the controller 31 of the FAX apparatus 30 performs the preparation of the session establishment and, after that, transmits the “200 OK” to the HGW 60 (Step S630). Next, the controller 61 of the HGW 60 that receives the “200 OK” transmits the response signal to the FAX apparatus 40 (Step S640) and transmits the “ACK” to the FAX apparatus 30 (Step S650). Through the aforementioned Steps S600 to S650, the connection establishment is obtained by the FAX protocol connection establishment process, and the call control process of Steps S510 to S650 is ended. If the call control process is ended, the HGW 60 continuously functions as the VoIP gateway to perform the protocol conversion between T.30 scheme and the considered audio scheme and performs the FAX communication start process, the capability adjustment process, the line state checking process, the printing contents transmission/reception process, and the call disconnection process, so that the printing contents are transmitted from the FAX apparatus 40 to the FAX apparatus 30. In addition, in comparison with the processes in the aforementioned T.30 scheme, in each of the FAX communication start process, the capability adjustment process, the line state checking process, and the printing contents transmission/reception process in the considered audio scheme, the formats of transmitted and received data are different but the contents of the data and the sequences of the process are the same.

If the call control process is ended, the controller 41 of the FAX apparatus 40 transmits “CNG” to the HGW 60 as a FAX communication start process (Step S660). Subsequently, the controller 61 of the HGW 60 transmits the received “CNG” to the FAX apparatus 30 (Step S665); and the controller 31 of the FAX apparatus 30 that receives the “CNG” transmits “CED” to the HGW 60 (Step S670); and the controller 61 of the HGW 60 transmits the received “CED” to the FAX apparatus 40 (Step S675). Due to the FAX communication start process, the FAX apparatus 40 is configured to be ready to perform FAX communication.

If the FAX communication start process is ended, the controller 31 of the FAX apparatus 30 first transmits to the HGW 60 “DIS” including the reception side capability information representing the capability of the FAX apparatus 30, that is, a terminal of reception side of receiving and printing the printing contents or the communication speed information representing the communication speed of the FAX apparatus 30 as a capability adjustment process for adjusting the capability used for the current printing contents transmission/reception (Step S680). Herein, as the capability of the FAX apparatus 30 represented by the reception side capability information, the size of the image data is A4 or B5; the resolution is 200×200 dpi; and the encode type is tiff; and the color type is monochrome. As the communication speed represented by the communication speed information is 14.4 kbits/second. Subsequently, the HGW 60 transmits the received “DIS” to the FAX apparatus 40 (Step S685).

If the FAX apparatus 40 receives the “DIS” of Step S700, similarly to Steps S320 and 330 in FIG. 2, the controller 41 determines the use capability and the communication speed used for the current printing contents transmission/reception within a range of the transmission side capability, that is, the printing contents transmission capability of the FAX apparatus 40 and within a range of the capability represented by the reception side capability information included in the “DIS” (Steps S690 and 700). As described above, as the transmission side capability of the FAX apparatus 40, the size of the image data is A4 or B5; the resolution is 200×200 dpi; the encode type is tiff; and the color type is color or monochrome. The communication speed is 9.6 kbits/second. Therefore, the size of the image data of A4, the resolution of 200×200 dpi, the encode type of tiff, and the color type of monochrome are determined as the use capability, and 9.6 kbits/second is determined as the currently-used communication speed.

If the use capability and the used communication speed are determined, the controller 41 transmits to the HGW 60 the “DCS” including the use capability information representing the use capability and the communication speed information representing the determined communication speed (Step S710). The controller 61 of the HGW 60 transmits the received “DCS” to the FAX apparatus 30 and notifies the determined use capability and communication speed (Step S715). Accordingly, the FAX apparatus 30 can check the capability and communication speed that are used by the FAX apparatus 40 for the current printing contents transmission/reception. Through the aforementioned Steps S680 to S715, the capability adjustment process is ended.

If the aforementioned capability adjustment process is ended, the controller 41 of the FAX apparatus 40 first transmits the “TCF” to the HGW 60 at the currently-used communication speed determined in Step S700 as the line state checking process for checking the communication line between the FAX apparatus 40 and the FAX apparatus 30 (Step S720). Next, the controller 61 of the HGW 60 transmits the received “TCF” to the FAX apparatus 30 (Step S725). If there is no 1-bit error in the received “TCF”, the controller 31 of the FAX apparatus 30 transmits to the HGW 60 a signal “CFR (confirmation to receive)” indicating that there is no error (Step S730), and the HGW 60 transmits to the received “CFR” to the FAX apparatus 40 (Step S735). Through the line state checking process of the Steps S720 to S735, it can be checked that the communication can be performed at the communication speed notified in Steps S710 and S715, and the printing contents transmission/reception hereinafter is determined to be performed at this communication speed. In addition, in the process of the case where there is an error in the “TCF” received by the FAX apparatus 30, as described above, the communication speed is allowed to be lowered step by step, and the transmitting and reception of the “TCF” and “FTT” are repeated to finally determine the currently-used communication speed.

If the line state checking process is ended, the controller 41 of the FAX apparatus 40 generates the one-page printing contents data in the format used for the T.30 scheme and the use capability determined in Step S690 and transmits to the HGW 60 the one-page printing contents data at the communication speed determined in the line state checking process as the printing contents transmission/reception process for transmitting the printing contents from the FAX apparatus 40 to the FAX apparatus 30 (Step S740) (refer to FIG. 14). The controller 61 of the HGW 60 transmits the received one-page printing contents data to the FAX apparatus 30 (Step S745). Next, the controller 31 of the FAX apparatus 30 stores the received printing contents data in the memory 34 and controls the printing performing unit 32 to print the printing contents data stored in the memory 34.

On the other hand, if the transmission of the one-page printing contents data in Step S740 is completely ended and if it is determined that there is a next page in the printing contents, the controller 41 of the FAX apparatus 40 transmits the “MPS” to the HGW 60 (Step S750), and the HGW 60 transmits the received “MPS” to the FAX apparatus 30 (Step S755). If all the one-page printing contents data transmitted in Step S745 are received and if the “MPS” of Step S755 is received, the controller 31 of the FAX apparatus 30 transmits the “MCF” to the HGW 60 (Step S760), and the controller 61 of the HGW 60 transmits the received “MCF” to the FAX apparatus 40 (Step S765).

Through the aforementioned Steps S740 to S765, the page transmission/reception process for transmitting the one-page printing contents data from the FAX apparatus 40 to the FAX apparatus 30 is ended. After that, until the transmission/reception of the one page before the last page of the printing contents is completed, the page transmission/reception process of the Steps S740 to S765 is repeated. Next, in the page transmission/reception process for the last page of the printing contents in the Steps S770 to S795, the same process as that of the Steps S740 to S765 is performed except that the “MPS” is replaced with the “EOP” in Steps S780 and S785. By the aforementioned Steps S740 to S795, the printing contents transmission/reception process is ended.

If the printing contents transmission/reception process is ended, the controller 41 of the FAX apparatus 40 transmits “DCN” to the HGW 60 as the call disconnection process for ending the connection (Step S800) (refer to FIG. 13). Subsequently, the controller 41 transmits a disconnection signal to the HGW 60 (Step S810). Accordingly, the connection between the FAX apparatus 40 and the HGW 60 is ended. In addition, if the “DCN” is received, the controller 61 of the HGW 60 transmits the “DCN” to the FAX apparatus 30 (Step S805). If the disconnection signal is received, the controller 61 transmits the “BYE” to the FAX apparatus 30 (Step S820). Next, the FAX apparatus 30 receiving the “BYE” transmits the “200 OK” to the HGW 60 (Step S830), so that the connection between the HGW 60 and the FAX apparatus 30 is ended.

On the other hand, if the disconnection signal of Step S810 is relayed, the controller 71 of the converter 70 considers the connection to be ended, so that an affirmative determination is made in Step S940 (refer to FIG. 4) and the protocol determination routine is ended.

In addition, hereinbefore, the operations of the converter 70 at the time of initially transmitting the printing contents from the FAX apparatus 40 to the FAX apparatus 30 are described. Next, the case of transmitting the printing contents in the second or later order is described. In the case where the printing contents are transmitted from the FAX apparatus 40 to the FAX apparatus 30 in the second or later order, the processes of Steps S510 to S540 of FIG. 13 are the same as those of the first order. However, if the protocol determination routine of FIG. 4 starts with Step S540, since the identification information of the FAX apparatus 30 is stored in the identification information storage area 74a, the controller 71 makes an affirmative determination in Step S900. Subsequently, the controller 71 determines whether or not the time represented by the time information stored in the identification information storage area 74a in correspondence with the identification information represents the time before the current time by a predetermined time interval or more (Step S1070). Herein, in the embodiment, the predetermined time interval is set to three months. Therefore, in the identification information storage area 74a, since the data corresponding to the identification information of the FAX apparatus 30, that is, the current transmission site is “2009/3/20”, if the current date in a format of year/month/day indicated by the internal clock of the converter 70 is “2009/6/20” or later, an affirmative determination is made. If the current date is before “2009/6/19”, a negative determination is made.

Next, when a negative determination is made in Step S1070, the connection cannot be established by performing the HTTP connection establishment process within a predetermined time interval, the terminal of the printing contents transmission site is considered to be the terminal of receiving and printing the printing contents according to not the HTTP but the considered audio scheme. The controller 71 proceeds to the Step S960 without performing of the HTTP connection establishment process to start the FAX protocol relaying process. Accordingly, Steps S550 and S560 of FIG. 13 are not performed, but the process of Step S570 or later is performed. In other words, when the terminal of the transmission site is considered to be the terminal of receiving and printing the printing contents according to the considered audio scheme, the FAX protocol connection establishment process is initially performed by the HGW 60, so that the process after the connection establishment is performed.

On the other hand, when an affirmative determination is made in Step S1070, the controller 71 proceeds to Step S910 to start the HTTP connection establishment process. This configuration is employed for the following reasons. A predetermined time interval or more elapse from the time when the connection establishment cannot be obtained through the last-time HTTP connection establishment process. During the time period, a user of the FAX apparatus 30 may consider to add an apparatus by replacing the FAX apparatus 30. Therefore, even the terminal of the transmission site specified by the same identification information may be able to receive the printing contents according to the HTTP at the current time. Therefore, similarly to the time that the printing contents are initially transmitted from the aforementioned FAX apparatus 40 to the FAX apparatus 30, the converter 70 performs the process of Step S140 (S550) hereinafter. Next, when the “180 Ringing” is transmitted from the terminal of the transmission site similarly to Step S150 of FIG. 2, the same process as that of Steps S160 to S190 of FIG. 2 is performed, so that the connection in the format used for the HTTP is established. In this case, an affirmative determination is made in Step S920 of the protocol determination routine of FIG. 4, and after that, the printing contents are transmitted through Step S200 or the later shown in FIG. 2 and the same sequence as that shown in FIG. 3. On the other hand, after the process of Step S140 (S550) is performed, when the “4xxerror” is transmitted from the terminal of the transmission site similarly to Step S560 of FIG. 13, a negative determination is made in Step S920 of the protocol determination routine of FIG. 4, and after that, the printing contents are transmitted through Step S570 or the later shown in FIG. 13 and the same sequence as that shown in FIG. 14. In addition, at this time, although Step S950 of the protocol determination routine is performed, since the identification information of the FAX apparatus 30 and the time information are stored in the identification information storage area 74a in advance, the identification information of the FAX apparatus 30 and the time information are overwritten and stored in identification information storage area 74a. In other words, a plurality of the same identification information needs not to be stored in the identification information storage area 74a, and with respect to the time information corresponding to the identification information, the time information at the time of finally performing the Step S950 is stored.

Herein, the correspondence between the elements of the embodiment and the elements of the invention is clearly described. The FAX apparatus 40 of the embodiment corresponds to a transmitting terminal of the invention. The multifunctional apparatus 20 and the FAX apparatus 30 correspond to a receiving terminal. The FAX apparatus 30 corresponds to a FAX receiving terminal. The multifunctional apparatus 20 corresponds to an HTTP receiving terminal. The HGW 60 corresponds to a home gateway. The converter 70 corresponds to a signal conversion apparatus. The I/F 75 corresponds to a first input/output unit. The I/F 76 corresponds to a second input/output unit. The I/F 77 corresponds to a third input/output unit. The controller 71 corresponds to a data transmission/reception unit. The memory 74 corresponds to a storage unit. In addition, the T.30 scheme corresponds to an analog FAX protocol. The considered audio scheme corresponds to a digital FAX protocol. The processes of Steps S320 to S460 in FIG. 3 performed by the controller 71 of the converter 70 correspond to an HTTP conversion process. The processes of Steps S740 to S795 performed by the controller 61 of the HGW 60 correspond to a FAX protocol conversion process.

In the in the aforementioned embodiment, if the converter 70 receives the selection signal according to the T.30 scheme from the FAX apparatus 40 through the I/F 75, the controller 71 first performs the HTTP connection establishment process to try to perform the connection to the receiving terminal specified by the identification information included in the selection signal. Next, when the connection is established, the receiving terminal is consider to be the terminal for receiving and printing the printing contents according to the HTTP. The protocol conversion between the T.30 scheme and the HTTP is performed, and the transmission of the printing contents from the FAX apparatus 40 to the receiving terminal is performed according to the printing contents transmission/reception process. In addition, when the connection is not established, the receiving terminal is considered to be the terminal for receiving and printing the printing contents according to the considered audio scheme to perform the FAX protocol relaying process. The HGW 60 that receives the selection signal according to the T.30 scheme performs the FAX protocol connection establishment process to perform the connection between the FAX apparatus 40 and the receiving terminal. The HGW 60 performs the protocol conversion between the T.30 scheme and the considered audio scheme, so that the printing contents can be transmitted from the FAX apparatus 40 to the receiving terminal through the printing contents transmission/reception process. In this manner, by connecting the converter 70 between the FAX apparatus 40 that transmits the printing contents according to the T.30 scheme and the HGW 60 that performs the protocol conversion between the T.30 scheme and the considered audio scheme, the printing contents can be transmitted to the multifunctional apparatus 20 that receives the printing contents from the FAX apparatus 40 according to the HTTP and prints the printing contents, and the transmission of the printing contents from the FAX apparatus 40 to the FAX apparatus 30, which can be performed only by the FAX apparatus 40 and the HGW 60, cannot be avoided. Therefore, with respect to the receiving terminal that receives and prints the printing contents according to any one of the considered audio scheme and the HTTP, the printing contents can be transmitted from the FAX apparatus 40 that transmits the printing contents according to the T.30 scheme. In addition, if the selection signal is received, the HTTP connection establishment process is first performed. According to whether or not the connection is established, it is determined whether or not the receiving terminal is the receiving terminal that receives the printing contents according to any one of the HTTP and the considered audio scheme. Therefore, even in the case where it is unclear which protocol the receiving terminal is the receiving terminal that receives the printing contents according to, the transmission of the printing contents to the receiving terminal can be performed.

In addition, before the HTTP connection establishment process is performed, the controller 71 performs the process of Step S900 for determining whether the identification information of the receiving terminal included in the received selection signal is stored as the identification information of the receiving terminal, of which the connection establishment cannot be obtained through the HTTP connection establishment process, in the identification information storage area 74a. If an affirmative determination is made, the controller 71 considers the receiving terminal to be the terminal that receives the printing contents according to the considered audio scheme and performs the FAX protocol relaying process without performing of the HTTP connection establishment process. If a negative determination is made, the controller 71 performs the HTTP connection establishment. In addition, when the connection establishment cannot be obtained through the HTTP connection establishment process, the controller 71 stores the identification information of the receiving terminal that tries to connect as the identification information of the receiving terminal, of which the connection establishment cannot be obtained through the HTTP connection establishment process, in the identification information storage area 74a. Accordingly, with respect to the receiving terminal of which the connection establishment cannot be obtained through the one-time HTTP connection establishment process, in the case where the printing contents are transmitted later, the connection is initially established in the format used for the considered audio scheme suitable for the receiving terminal, so that the printing contents can be transmitted.

In addition, when the controller 71 makes an affirmative determination as a result of performing the process of Step S900, in the case where the time information stored in correspondence with the identification information indicates a time less than a predetermined time interval from the current time, the controller 71 performs the FAX protocol relaying process without performing of the HTTP connection establishment process. In the case where the time information stored in correspondence with the identification information indicates a time before a predetermined time interval or more from the current time, the controller 71 performs the HTTP connection establishment process. In addition, when the connection cannot be established through the HTTP connection establishment process, the controller 71 stores the identification information of the receiving terminal, which tries to connect, as the identification information of the receiving terminal, of which the connection establishment cannot be obtained through the HTTP connection establishment process, and stores the time information indicating the storing time in correspondence with the identification information in the identification information storage area 74a. Accordingly, even in the receiving terminal that is considered to be the receiving terminal of which the connection establishment cannot be obtained through the one-time HTTP connection establishment process, if a predetermined time or more elapses, since the HTTP connection establishment process is tried, in the case where the receiving terminal has a function of receiving and printing the printing contents according to the HTTP, the printing contents can be detected, and after that, the printing contents can be transmitted according to the HTTP.

In addition, the invention is not limited to the aforementioned embodiment. The invention can be implemented in various forms within the scope of the invention.

For example, in the aforementioned embodiment, only the identification information of the receiving terminal, of which the connection establishment cannot be obtained through the HTTP connection establishment process, is stored in the identification information storage area 74a of the memory 74. However, the identification information of the receiving terminal, of which the connection establishment can be obtained through the HTTP connection establishment process, may be stored. For example, the identification information and the availability on connection establishment may be stored in the identification information storage area 74a in a correspondence manner. In this case, when an affirmative determination is made in Step S920, the identification information of the receiving terminal, of which the connection establishment can be obtained through the HTTP connection establishment process, may be stored.

In the aforementioned embodiment, the identification information and the time information are stored in the identification information storage area 74a in Step S950 of the protocol determination routine in a correspondence manner. However, only the identification information may be stored. In this case, the process of Step S1070 may not be performed, and if an affirmative determination is made in Step S900, the procedure proceeds to Step S960.

In the aforementioned embodiment, it is determined through Step S900 of the protocol determination routine whether or not the identification information is stored in the identification information storage area 74a. However, the process of Step S900 may not be performed. In this case, if the protocol determination routine starts, the process of Step S910 may be first performed, and if a negative determination is made in Step S920, the procedure proceeds to Step S960.

In the aforementioned embodiment, the converter 70 is configured to be connected between the HGW 60 and the FAX apparatus 40. However, an apparatus that integrally includes the converter 70 and the HGW 60 may be configured to be connected between the FAX apparatus 40 and the IP network 11. For example, in this case, the apparatus may includes a controller having all the functions of the controllers 71 and 61, a memory having all the functions of the memories 74 and 64, an I/F 75, and an I/F 65. This apparatus can also obtain the same effects as those of the aforementioned embodiment.

In the aforementioned embodiment, the time information is configured to indicate the storing date in a format of year/month/day. When the identification information is stored as the identification information of the receiving terminal, of which the connection establishment cannot be obtained through the HTTP connection establishment process, any information indicating the storing time may be used. For example, in addition to the date in a format of year/month/day, the time in a format of hour/minute/second may also be used as the time information. The time information in a format of year may be used. In addition, the predetermined time interval is set to three months, but not limited thereto. Any time interval such as one year or 100 days may be used.

In the aforementioned embodiment, the FAX apparatus 30 is configured to be the apparatus for receiving and printing the printing contents according to the considered audio scheme. However, any apparatus that can perform the data transmission/reception through the HGW 60 and the IP network 11 in the format used for the considered audio scheme may be used. For example, a FAX apparatus that receives and prints the printing contents according to the T.30 scheme may be connected to the IP network 11 through a home gateway that performs the protocol conversion between the T.30 scheme and the considered audio scheme. In this case, as viewed from the HGW 60, the FAX apparatus and the home gateway integrally function as the apparatus for receiving and printing the printing contents according to the considered audio scheme, so that the printing contents can be transmitted similarly to the embodiment.

In the aforementioned embodiment, the multifunctional apparatus 20 is configured to include the scan performing unit 23 and the memory card driver 26. However, any apparatus capable of receiving and printing the printing contents according to the HTTP may be used. In addition, a portion or the entire thereof may not be included.

In the aforementioned embodiment, the FAX apparatus 40 is configured as a G3 compatible FAX of transmitting the printing contents according to the T.30 scheme. A FAX apparatus of performing the printing contents transmission/reception according to the T.30 scheme, which is compatible with G1, G2, or Super-G3, may be used. In addition, in the aforementioned embodiment, the considered audio scheme is exemplified as a digital FAX protocol. Instead of the considered audio scheme, other digital FAX protocols may be used. For example, instead of the considered audio scheme, a T38 scheme (real-time scheme) may be used. This protocol is different from the considered audio scheme or the T.30 scheme in terms of a data format, but the sequences of the processes and the contents of data are the same as those of the considered audio scheme or the T.30 scheme. Therefore, similarly to the aforementioned embodiment, the signal conversion apparatus according to the invention may be adapted.

What is claimed is:

1. A signal conversion apparatus which is connected between a transmitting terminal which transmits printable printing contents according to an analog FAX protocol and a home gateway, which is connected to an IP network, to which a FAX receiving terminal that receives and prints the printing contents according to a digital FAX protocol or an HTTP receiving terminal that receives and prints the printing contents according to HTTP as a receiving terminal that receives and prints the printing contents is connected, which, when the transmitting terminal receives a connection request signal output in a format used for the analog FAX protocol so as to transmit the printing contents, performs a FAX protocol connection establishment process of performing data transmission/reception in the format used for the transmitting terminal and the analog FAX protocol and performing data transmission/reception through the IP network in the format used for the FAX receiving terminal and the digital FAX protocol to obtain connection establishment between the transmitting terminal and the FAX receiving terminal and a FAX protocol conversion process of receiving the printing contents in the format used for the analog FAX protocol from the transmitting terminal after the connection establishment, converting the received printing contents into the format used for the digital FAX protocol, and transmitting the converted printing contents to the FAX receiving terminal through the IP network, and which, when data in the format used for the HTTP is received, performs an HTTP relaying process of relaying the data without change, the signal conversion apparatus comprising:
a first input/output unit which can input and output data through the transmitting terminal and a telephone line;
a second input/output unit which can input and output data through the home gateway and a LAN cable;
a third input/output unit which can input and output data through the home gateway and the telephone line; and
a data transmission/reception unit which performs data transmission/reception with respect to the transmitting terminal by using the first input/output unit and data transmission/reception with respect to the home gateway by using the second input/output unit or the third input/output unit,
wherein, when the connection request signal is received through the first input/output unit, the data transmission/reception unit performs an HTTP connection establishment process of trying to obtain the connection establishment between the transmitting terminal and the receiving terminal by performing the data transmission/reception in the format used for the transmitting terminal and the analog FAX protocol through the first input/output unit and performing the data transmission/reception in the format used for the receiving terminal and the HTTP through the second input/output unit, the home gateway, and the IP network,
wherein, when the connection establishment can be obtained through the HTTP connection establishment process, the data transmission/reception unit performs an HTTP conversion process of transmitting the printing contents to the connected receiving terminal through the second input/output unit, the home gateway, and the IP network by considering the receiving terminal that tries to connect to be an HTTP receiving terminal, receiving the printing contents in the format used for the analog FAX protocol from the transmitting terminal through the first input/output unit, and converting the received printing contents into the format used for the HTTP, and
wherein, when the connection establishment cannot be obtained through the HTTP connection establishment process, the data transmission/reception unit performs a FAX protocol relaying process of performing a process of considering the receiving terminal that tries to connect to be a FAX receiving terminal and transmitting the connection request signal, which is received through the first input/output unit, to the home gateway in the format used for the analog FAX protocol through the third input/output unit and a process of relaying the data, which are received and transmitted by the transmitting terminal and the home gateway, without change through the first input/output unit and the third input/output unit.

2. The signal conversion apparatus according to claim 1, further comprising:
a storage unit which can store identification information of the receiving terminal included in the connection request signal as identification information of the receiving terminal, of which the connection establishment cannot be obtained through the HTTP connection establishment process,
wherein, when the connection request signal is received, before the HTTP connection establishment process is performed, the data transmission/reception unit determines whether or not the identification information of the receiving terminal included in the connection request signal is stored as the identification information of the receiving terminal, of which the connection establishment cannot be obtained through the HTTP connection establishment process, in the storage unit,
wherein, when an affirmative determination is made, the data transmission/reception unit considers the receiving terminal to be the FAX receiving terminal and performs the FAX protocol relaying process without performing of the HTTP connection establishment process,
wherein, when a negative determination is made, the data transmission/reception unit performs the HTTP connection establishment process,
wherein, when the connection establishment can be obtained through the HTTP connection establishment process, the data transmission/reception unit performs the HTTP conversion process, and
wherein, when the connection establishment cannot be obtained through the HTTP connection establishment process, the data transmission/reception unit performs a process of storing the identification information of the receiving terminal that tries to connect as the identification information of the receiving terminal, of which the connection establishment cannot be obtained through the HTTP connection establishment process in the storage unit and performs the FAX protocol relaying process.

3. The signal conversion apparatus according to claim 2,
wherein the storage unit is a unit which stores time information indicating the storing time in correspondence with the identification information when the identification information is stored as the identification information of the receiving terminal, of which the connection establishment cannot be obtained through the HTTP connection establishment process,
wherein, when the data transmission/reception unit receives the connection request signal and make an affirmative determination by performing the determination before the HTTP connection establishment process is performed, in the case where the identification information of the receiving terminal included in the received connection request signal and the time information indicating the time less than a predetermined time interval from the current time are stored in a correspondence manner, the data transmission/reception unit performs the FAX protocol relaying process without performing of the HTTP connection establishment process,
wherein, in the case where the identification information of the receiving terminal included in the received connection request signal and the time information indicating the time more than a predetermined time interval before from the current time are stored in a correspondence manner, the data transmission/reception unit performs the HTTP connection establishment process,
wherein, when the connection establishment can be obtained through the HTTP connection establishment process, the data transmission/reception unit performs the HTTP conversion process, and
wherein, when the connection establishment cannot be obtained through the HTTP connection establishment process, the data transmission/reception unit performs the process of storing the identification information of the receiving terminal that tries to connect as the identification information of the receiving terminal, of which the connection establishment cannot be obtained through the HTTP connection establishment process and storing the time information indicating the storing time in correspondence with the identification information and the FAX protocol relaying process.

4. A signal conversion apparatus which is connected between a transmitting terminal which transmits printable printing contents according to an analog FAX protocol and an IP network to which an FAX receiving terminal that receives and prints the printing contents according to a digital FAX protocol or an HTTP receiving terminal that receives and prints the printing contents according to HTTP as a receiving terminal that receives and prints the printing contents is connected, the signal conversion apparatus comprising:
a data transmission/reception unit which performs data transmission/reception with respect to the transmitting terminal and data transmission/reception with respect to the receiving terminal through the IP network,
wherein, when a connection request signal that is transmitted by the transmitting terminal so as to transmit the printing contents is received, the data transmission/reception unit performs an HTTP connection establishment process of trying to obtain the connection between the transmitting terminal and the receiving terminal by performing the data transmission/reception in the format used for the transmitting terminal and the analog FAX protocol and performing the data transmission/reception in the format used for the receiving terminal and the HTTP through the IP network
wherein, when the connection establishment can be obtained through the HTTP connection establishment process, the data transmission/reception unit performs an HTTP conversion process of transmitting the printing contents to the connected receiving terminal through the IP network by considering the receiving terminal that tries to connect to be an HTTP receiving terminal, receiving the printing contents in the format used for the analog FAX protocol from the transmitting terminal, and converting the received printing contents into the format used for the HTTP,
wherein, when the connection establishment cannot be obtained through the HTTP connection establishment process, the data transmission/reception unit performs a FAX protocol connection establishment process of considering the receiving terminal that tries to connect as a FAX receiving terminal, performing data transmission/reception in the format used for the transmitting terminal and the analog FAX protocol, and performing data transmission/reception through the IP network in the format used for the receiving terminal and the digital FAX protocol to obtain connection establishment between the transmitting terminal and the receiving terminal and a FAX protocol conversion process of receiving the printing contents in the format used for the analog FAX protocol from the transmitting terminal after the connection establishment, converting the received printing contents into the format used for the digital FAX protocol, and transmitting the converted printing contents to the receiving terminal through the IP network.

5. The signal conversion apparatus according to claim 4, further comprising
a storage unit which can store identification information of the receiving terminal included in the connection request signal as identification information of the receiving terminal, of which the connection establishment cannot be obtained through the HTTP connection establishment process,
wherein, when the connection request signal is received, before the HTTP connection establishment process is performed, the data transmission/reception unit determines whether or not the identification information of the receiving terminal included in the connection request signal is stored as the identification information of the receiving terminal, of which the connection establishment cannot be obtained through the HTTP connection establishment process, in the storage unit,
wherein, when an affirmative determination is made, the data transmission/reception unit considers the receiving terminal to be the FAX receiving terminal and performs the FAX protocol connection establishment process without performing of the HTTP connection establishment process, and performs the FAX protocol conversion process after the connection establishment,
wherein, when a negative determination is made, the data transmission/reception unit performs the HTTP connection establishment process,
wherein, when the connection establishment can be obtained through the HTTP connection establishment process, the data transmission/reception unit performs the HTTP conversion process,
wherein, when the connection establishment cannot be obtained through the HTTP connection establishment process, the data transmission/reception unit stores the identification information of the receiving terminal that tries to connect as the identification information of the receiving terminal, of which the connection establishment cannot be obtained through the HTTP connection establishment process in the storage unit and performs the FAX protocol connection establishment process, and performs the FAX protocol conversion process after the connection establishment.

6. The signal conversion apparatus according to claim 5,
wherein the storage unit is a unit which stores time information indicating the storing time in correspondence with the identification information when the identification information is stored as the identification information of the receiving terminal, of which the connection establishment cannot be obtained through the HTTP connection establishment process,
wherein, when the data transmission/reception unit receives the connection request signal and make an affirmative determination by performing the determination before the HTTP connection establishment process is performed, in the case where the identification information of the receiving terminal included in the received connection request signal and the time information indicating the time less than a predetermined time interval from the current time are stored in a correspondence manner, the data transmission/reception unit performs the FAX protocol connection establishment process without performing of the HTTP connection establishment process, and performs the FAX protocol conversion process after the connection establishment,
wherein, in the case where the identification information of the receiving terminal included in the received connection request signal and the time information indicating the time more than a predetermined time interval before from the current time are stored in a correspondence manner, the data transmission/reception unit performs the HTTP connection establishment process,
wherein, when the connection establishment can be obtained through the HTTP connection establishment process, the data transmission/reception unit performs the HTTP conversion process, and
wherein, when the connection establishment cannot be obtained through the HTTP connection establishment process, the data transmission/reception unit stores the identification information of the receiving terminal that tries to connect as the identification information of the receiving terminal, of which the connection establishment cannot be obtained through the HTTP connection establishment process and storing the time information indicating the storing time in correspondence with the identification information, performs the FAX protocol connection establishment process, and performs the FAX protocol conversion process after the connection establishment.
